(19) United States
(12) Patent Application Publication
(10) Pub. No.: US 2010/0153453 A1
(43) Pub. Date: Jun. 17, 2010

(54) COMMUNICATION METHOD, SYSTEM AND PRODUCTS

(75) Inventor: Karen Knowles, Victoria (AU)

Correspondence Address: BROOKS KUSHMAN P.C., 1000 TOWN CENTER, TWENTY-SECOND FLOOR, SOUTHFIELD, MI, 48075, US

(73) Assignee: KAREN KNOWLES ENTERPRISES PTY LTD, Surrey Hills, Victoria (AU)

(21) Appl. No.: 12/666,539

(22) PCT Filed: Jun. 27, 2008
(86) PCT No.: PCT/AU2008/000938

§ 371 Date: Dec. 23, 2009

(30) Foreign Application Priority Data
Jun. 27, 2007 (AU) 2007903465
Jun. 28, 2007 (AU) 2007903492
Jul. 13, 2007 (AU) 2007903811
Oct. 18, 2007 (AU) 2007905723
Nov. 26, 2007 (AU) 2007906447
Feb. 11, 2008 (AU) 2008900618

(51) Int. Cl. G06F 15/16; G06F 17/30

(52) U.S. Cl. 707/784; 709/206; 707/E17.005

(57) ABSTRACT

The present invention provides a communication method and/or system (10) that enables the creation of personalised identifiers (40) and/or language that can be used to convey information, messages, instructions, and/or attributes for the purpose of enhancing and/or integrating communications. In a preferred form the personalised identifiers (40) and/or language can act as elements that may be used as a means of expression that is driven by users (12), groups of users (12), or entities, in order to convey personal attributes or identity. In a further preferred form the personalised identifiers (40) may act as visual representations of identity in order to, for example, facilitate convenient and readily accessible means of cross-referencing indexed information. The present invention may also provide refined search facilities that feature graphical functions that enable enhanced visualisation of search results, and/or visualisation display applications.

### TECHNICAL FIELD

The present invention relates generally, to methods and systems of communication, and relates particularly, though not exclusively, to a method and/or system of communication, and products related thereto, that may allow for, but are not limited to: the personalisation of messages sent via communications and/or computing devices, or applications for same; the self-expression of users of such devices; the creation of identifiers for users, or groups of users, etc, using multi-faceted and/or multi-sensory representations; the incorporation of such identifiers into existing means of profiling users, by way of, for example, membership clubs, frequent flyer clubs, medical IDs, etc; the identification of networks of interest groups, associations, corporations, value based affiliations and/or other groupings via the use of such multi-faceted and/or multi-sensory representations or identifiers; mapping and/or systemising of such identifiers and/or other attributes of users, groups of users, or networks, into reports, visual displays or front-ends, and/or information repositories or libraries that may be readily accessed to quickly identify information relevant to those users, groups of users, or networks; and/or, the utilisation of such identifiers to act either solely or in conjunction with text as an advanced search tool when searching for information, or making selections, for programming or other user needs based on user attributes.

It will be convenient to hereinafter describe the invention in relation to a system and/or method of messaging-type communication, however it should be appreciated that the present invention is not limited to that use only. The system and/or method of the present invention may also be used with or for other applications without departing from the spirit and scope of the invention as hereinafter described. Suitable forms of other applications include, but are not limited to: ordering systems; indexing systems; user-enhanced database systems; advanced search engine systems; digital television systems; retail systems; systems for personalising products; home automation systems; applications to identify cards; personalising data transfer; and/or, inventory or logistics systems. By way of an example, in the case of logistics or other types of ordering systems, stock items could each be assigned a footprint by the method and/or system of communication of the present invention which may be, for example, defined by the weight or another distinguishing factor of that item. Such footprints would create unique symbols, etc, that could be used within existing inventory systems for ordering and/or other stock related purposes.

Accordingly, throughout the ensuing description the expression “communication(s)” is intended to refer to the transmission of any suitable form of information, content, data, or language between various users, devices, means, or applications, for the purpose of conveying information, messages or instructions.

### BACKGROUND ART

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure herein.

It is common nowadays for people to message each other by way of SMS, MMS, voice messages, video messages, or e-mail, and more recently via web-based social networks such as, for example, Facebook or Myspace.

Communications devices such as mobile phones or Blackberrys, which these days double as a phone and computer, have become accessible lifestyle options and are currently one of the world's major tools for communication. People are spending more time than ever communicating with friends and family via means of communications devices. As the use of such devices increases, so too do peoples expectations of the communications capabilities of these devices.

It follows that users are now seeking an enhancement of current messaging and entertainment based systems which involve further personalisation that is time efficient, but that also enhances well-being and self-expression. People want to have their own identity demonstrated and integrated for use within the communications and/or computing devices they use each day, and in turn wish to have such devices interrelate and more efficiently give them what they desire.

The introduction and huge success of social networks like Facebook and Myspace has resulted in large numbers of people engaging in social activity on-line. Flowing on from this explosion of on-line social activity, people are now wishing to convey a more complete picture of who they are, who they wish to connect with, or with whom specific content is to be shared with in an on-line environment. Messaging on-line has traditionally been limited to text and some images.

To date, there have been few, if any, effective methods, systems and/or devices for providing a personalised communication means for use on-line, or with communications and/or computing devices.

It is therefore an object of the present invention to provide a method and/or system of communication, and preferably products related thereto, which allow for the transmission of personalised information or data.

### DISCLOSURE OF THE INVENTION

According to one aspect of the present invention there is provided a method of communication, said method including the steps of: providing a repository for storing and/or sharing identifiers and/or language; providing at least one user operable terminal with controlled access to said repository and said identifiers and/or language stored therein; wherein said identifiers and/or language are used to convey information, messages, instructions, attributes, and/or expression for the purpose of enhancing and/or integrating communications.

According to a further aspect of the present invention there is provided a communication system, said system being operable over a communications network, said system including: at least one memory or storage unit operable to store and/or maintain identifiers and/or language; at least one processor operable to execute software that maintains and controls access to said identifiers and/or language for a plurality of users; and, at least one input/output device operable to provide an interface for said plurality of users to operate said software in order to retrieve and/or update said identifiers and/or language, and/or elements thereof; wherein said identifiers and/or language, and/or elements thereof, are used to convey information, messages, instructions, attributes, and/or expression for the purpose of enhancing and/or integrating communications.

### ADVANTAGES OF THE INVENTION

Accordingly, the present invention provides an improved communication method, system and/or related products, which allows for the transmission of personalised information or data.

The present invention enables the creation of personalised information, content and/or data that can be used, for example, as a communication language for transmission between various communications an/or computing devices, and/or applications or interfaces installed/provided on same, such that individuals can, for example, express their own identity, mode or feelings when messaging their friends or family.

According to an advantageous embodiment, the present invention enables the creation of identifiers for users, groups of users, or networks, using multi-faceted or multi-sensory representations, which can used across multiple platforms, formats and/or applications to identity the expression, or other attributes, of those individuals, groups, or networks.

The method and/or system of communication of the present invention may also allow for (but is not limited to): (i) users to choose identifying language: for use as a tool of communication; for composite use as identifiers (e.g. ID and mood products—i.e. products that identify the user in a multi-faceted way); and, for various other uses and applications on any of their own, or a corporation's, chosen devices or systems; (ii) the creation of groups and networks that are easily identified by the use of identifiers and are effectively networked due to the use of the method and/or system of the present invention that allows for attributes of groups and networks to be identified and displayed; (iii) unique identifiers to be created to be utilised as an additional component to enhance search engine capabilities, creating outputs that are suitably targeted towards individual or group requirements; and, (iv) unique identifiers to be utilised to enhance an indexing system so that information can be more readily posted, accessed, and stored so that users have, for example, a visual display of staff and/or project mapping e.g.: (a) projects specific groups are involved with; (b) ID's of individual members, and group ID's, that denotes various aspects of the identity and other attributes of the individual or group; and, (c) where relevant information to each project can be categorised and posted for ready access.

A new way of communicating is therefore provided that is far more personalised than what has previously been available, one that provides a means of expression that is driven by users.

The method and/or system of communication of the present invention is suitable for various applications, across cross-media platforms and beyond.

### BRIEF DESCRIPTION OF THE DRAWINGS

In order that the invention may be more clearly understood and put into practical effect there shall now be described in detail preferred constructions of a method and/or system of communication in accordance with the invention. The ensuing description is given by way of non-limitative example only and is with reference to the accompanying drawings, wherein:

FIG. 1 is a diagram illustrating the operation of a project website or software application for use with a communication system of the present invention, the project website or application being made in accordance with a preferred embodiment of the present invention, the project website or application being used to create an ID display, and/or language, which can then be used as a means of communication via communications and/or computing devices, and/or other websites or applications;

FIG. 2 is a block diagram of a communication system made in accordance with a preferred embodiment of the present invention, the system being suitable for use with the preferred project website or application shown in FIG. 1, and illustrating the interaction of the preferred project website or application with various devices or applications by way of, for example, SMS and e-mail data transfer protocols;

FIG. 3 is a diagram illustrating the operation of a language creation module for use with a communication system of the present invention, the language creation module being made in accordance with a preferred embodiment of the present invention and suitable for use with the preferred project website or application shown in FIG. 1, and the communication system of FIG. 2;

FIG. 4a is a diagram illustrating a preferred visual display of a user's identifier or ID, showing how the various facets of a user's ID may be accessed independently and stored all in one file, the user ID being suitable for use with any one of the communication systems of the present invention;

FIG. 4b is a diagram illustrating an exemplary detailed view of an item within the profile of a user's ID, showing how further information may be accessed, viewed, and/or updated according to a preferred embodiment of the present invention;

FIG. 4c is a further diagram illustrating a preferred visual display of a user's ID, showing how the various facets of a user's ID may be created and accessed independently and stored all in one file, the user ID being suitable for use with any one of the communication systems of the present invention;

FIG. 4d is yet a further diagram illustrating a preferred visual display of a user's ID, this time showing how the various facets of a user's ID may be combined or overlapped for visual purposes, such that the resultant user ID is representative of their personal, group and project attributes, the user ID being suitable for use with any one of the communication systems of the present invention;

FIG. 5 is a flow diagram illustrating an embodiment of a preferred method of updating the mood status of a user of the communication system of the present invention;

FIG. 6 is a flow diagram illustrating an embodiment of a preferred method of retrieving the current mood status of a user of the communication system of the present invention;

FIG. 7 is a flow diagram illustrating an embodiment of a preferred method of utilising a user's ID and mood status for the purpose of conducting an enhanced television, or other programming search, the enhanced television or other programming search being made in accordance with a further preferred communication system of the present invention;

FIG. 8 is a flow diagram illustrating an embodiment of a preferred method of performing an advanced internet search utilising a user's ID, mood status, or other attribute identifiers or outputs, the advanced internet search being made in accordance with a yet further preferred communication system of the present invention;

FIG. 9 is a diagram illustrating exemplary products and/or devices that may be provided/used with any one of the communication methods and/or systems of the present invention;

FIG. 10a is a diagram illustrating a preferred visual display of a user identifier, or ID, for use with any one of the communication methods and/or systems of the present invention, the preferred user identifier being particularly suited to an indexing system made in accordance with a preferred embodiment of the present invention;

FIG. 10b is a diagram illustrating a preferred visual display of the way in which groups and/or networks may be created in accordance with any one of the communication methods and/or systems of the present invention, the preferred creation of groups and/or networks being particularly suited to an indexing system made in accordance with a preferred embodiment of the present invention;

FIG. 11 is a block diagram which illustrates various exemplary data constructs that can each be used in accordance with any one of the communication methods and/or systems of the present invention;

FIG. 12 is a block diagram which illustrates an exemplary method of populating an individual's “Mood and ID Profile” with the various data constructs available via system 10, and shown in FIG. 11;

FIGS. 13a to 13c are various exemplary Graphical User Interfaces (e.g. webpages) which illustrate a preferred embodiment of the way in which the communication method and/or system of the present invention may be utilised with a corporation;

FIGS. 14a to 14d are various diagrams which illustrate in detail the individual elements that are used within the exemplary corporation-based Graphical User Interfaces shown in FIGS. 13a to 13c;

FIGS. 15a & 15b are various diagrams which illustrate in detail the available views, and transition or break-away effects, provided by way of the exemplary corporation-based Graphical User Interfaces shown in FIGS. 13a to 13c;

FIG. 16 is a block diagram which illustrates how a user's personal ID profile created in accordance with any one of the communication methods and/or systems of the present invention can be applied to physical environments in accordance with preferred embodiments of the present invention;

FIG. 17 is a block diagram which illustrates how various programming and/or production services may interact and be used in accordance with a further preferred embodiment of a communication method and/or system of the present invention;

FIG. 18 is a block diagram which illustrates how a user's personal ID profile created in accordance with any one of the communication methods and/or systems of the present invention can be utilised with a karaoke application in accordance with a preferred embodiment of the present invention;

FIG. 19 is a block diagram which illustrates how a user's personal ID profile created in accordance with any one of the communication methods and/or systems of the present invention can be utilised with a music recording device in accordance with a preferred embodiment of the present invention;

FIG. 20 is a block diagram which illustrates an exemplary search mechanism that may be used in accordance with any one of the communication methods and/or systems of the present invention;

FIG. 21 is a flow diagram illustrating an exemplary process of query construction for use within the preferred search mechanism shown in FIG. 20;

FIG. 22 is similar view to that of FIG. 20, this time showing the preferred search mechanism in greater details for illustrative purposes; and,

FIG. 23 is a block diagram which illustrates an example of how the search mechanism of FIGS. 20 to 22 may be integrated into an organization and/or corporation.

### MODES FOR CARRYING OUT THE INVENTION

Throughout the ensuing description, where the expressions: “appearance”; “device”; “electronic”; “element of language”; “encapsulated content”; “identifier”; “image”; “language”; “message”; “movement”; “receives”; and, “video streaming”; are used, the following definitions may apply:

“Appearance”—includes by way of example, colour, brightness, tone, and degrees thereof, or any form or characteristic of visual appearance;

“Device”—includes by way of example, any piece of equipment, electronic or otherwise including a communications and/or computing device, mobile terminal, mobile or cell phone, PDA, television (including, but not limited to, internet, broadband, free to air, mobile television, and any future means of transmission of content or, due to convergence, incorporation of means of transmission), server, rights expression voucher, games console, such as, by way of example, Nintendo WII or Playstation 2 or 3, Flash Player, two way pager, palm pilot, pocket PC, auto PC, computer, appliance, and any other suitable electronic equipment that communicates in any format via any means or submits, transmits or remits data, symbols, language (as defined herein), sound, visual and any other form of sensory expression in any format via any means including energetic fields and other suitable forms of technology that may be considered a substitute for same in the future, or any component part of such a device, or any addition to a said device that enables the method and/or system of this invention; “Electronic”—includes, but is not limited to, digital, photonic, and any other form of technology that allows transmission of data or language including wireless, hard-wired, fibre-optic mediums, or any other technology that submits, transmits, stores or remits or assists in any of these processes the sending, receiving or processing of data, symbols, radio-waves, energy, or results in any other form of communication;

“Element of language”—includes by way of example, a word, phrase, musical motif, song, sound, image, animation or moving image, video streaming, encapsulated content, or snippet thereof in any format;

“Encapsulated content”—includes by way of example, content of any form captured via any means that has been put into a form suitable for transmission, submission or remission by or to a said device;

“Identifier”—includes by way of example, an individual, group, or network's ID crest (an icon that represents a user's identity in a multi-faceted way), a mood icon (that represents the user's mood); a contact icon, and other displays that display attributes of users, including real time multi-sensory displays of how they are communicating public perception displays, etc;

“Image”—means any form of visual representation including, but not limited to, a moving image, animated image, holographic image, and/or, any visual presentation in any singular or multiple format created by any means;

“Language”—includes, but is not limited to, any form of expression made up of symbols, icons, texture, smell, temperature, movement, appearance, spoken word, written word, visual language, moving images, video streaming, music clip streaming, sung or vocal form or music played on an instrument or other device, and/or any combination of the aforesaid which is understood by at least two persons or devices as language;

“Message”—includes, but is not limited, to any text message, voice message, video message, encapsulated content, or any other means of communication;

“Movement”—is defined to include by way of example a device or a device's component parts being able to pulse, vibrate, jump, spring, or make any other form of movement;

“Receives”—can mean in terms of receiving a message, receipt by a device, or the recipient opening the received message at the recipient's election which will necessarily occur at a later time than the device receiving the message; and,

“Video streaming”—means the delivery of any form of performance or action content, including but not limited to, concert performance, music video performances, action stunts, any type of footage captured on any form of camera or device, or snippets thereof in any format via any means.

In accordance with one preferred aspect of the present invention, a method and/or system of communication is provided that operates to give users the ability to personalize messaging-type communications with a group of associates, friends and/or family. This method and/or system of communication enables users to be involved in the interactive creation of their own language for use across/with communications and/or computing devices, applications, on-line environments, and/or any other forms of equipment which allow for such user personalization and communication.

While the application of such a method and/or system of communication will work on an individual basis to an extent, in order to partake in the full extent of the personalized communication process offered by the invention, specific users will be invited to identify themselves, and be given the option to create couplings or groups with other users of the system for the purpose of sharing their own created interactive evolving language which may include, but is not limited to, color, symbols, drawings, sounds, movement, and many other sensory facets or expressions that signify meanings to users.

In accordance with a preferred embodiment of the invention, users may be offered an existing set of choices or options of, for example, colors, symbols, drawings, sounds, and/or other sensory outputs, that are available to them for use for the purpose of creating their own communication language. Along with the preset sensory output options available, users may also be offered the opportunity to create their own language outputs which can be easily set for future use within the settings on their chosen communications device(s).

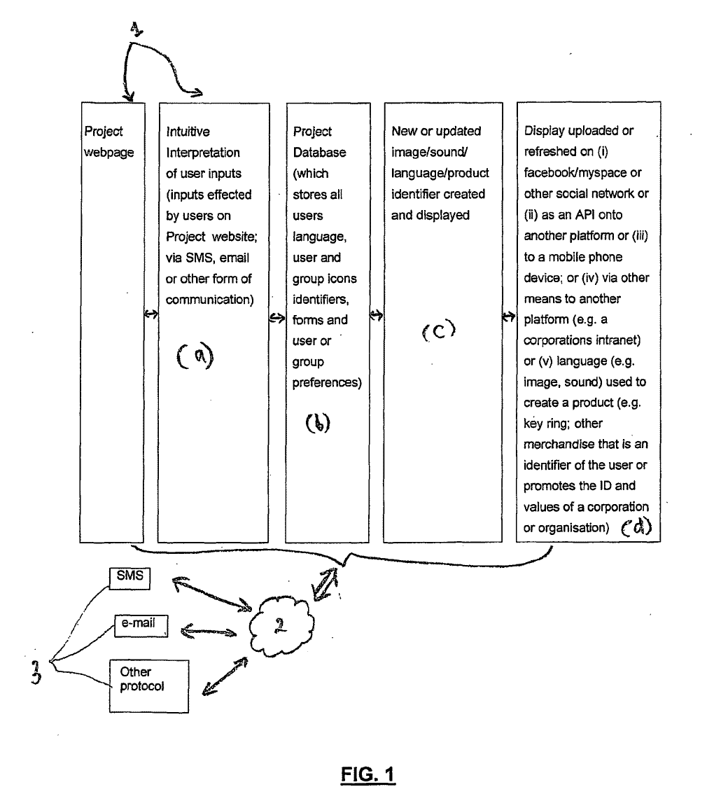

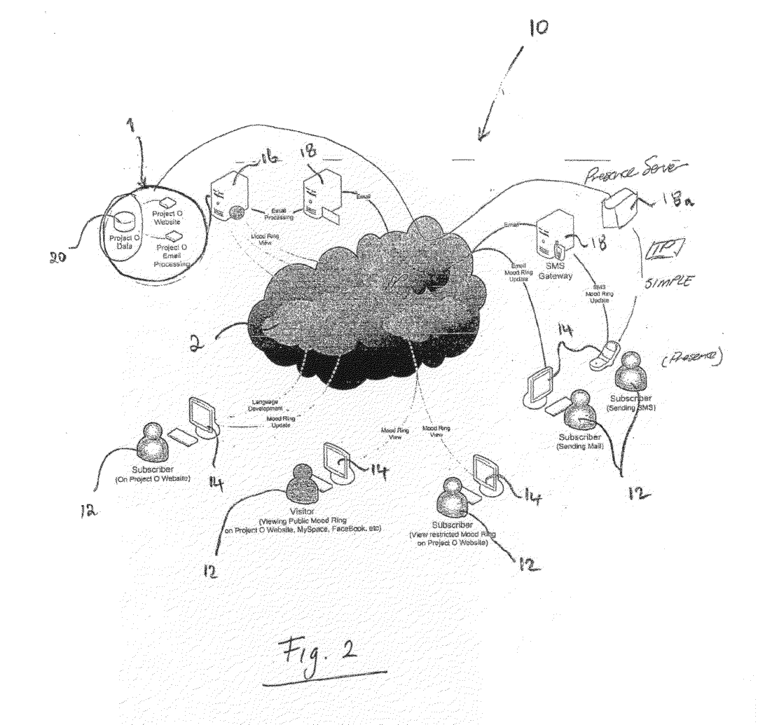

In FIG. 1, there is shown a diagrammatic representation of a project website or software application 1 (hereinafter referred to as “project website 1”), suitable for use with such a communication system 10 (see, for example, FIG. 2) of the present invention. Project website 1 is designed to be utilised by user's (not shown in FIG. 1) to create an ID display (discussed later in detail) or language which can then be used as a means of communication via a network 2, utilising any suitable communications and/or computing devices, and/or other websites or applications (not shown in FIG. 1), by way of any suitable data transfer protocol 3, for example, SMS or e-mail, as shown.

It will be appreciated that depending on the capability of the applicable device and/or application, and/or the specific data transfer protocol 3 used, in some instances, the overall language that is created via project website 1 may need to be compressed for delivery purposes via network 2. However, where possible, taking into account technical limitations on issues such as delivery, the message 3 will always remain easily accessible and within usual usage, and not fragmented into sections.

By personalizing, language that is used, for example, for text messaging purposes, user's can express their own personality within messages. Although there are currently some symbols available for use on existing phones, or similar devices, such prior art symbols are all set with no personal input from a user, and are quite limited in their scope and possible extent of expression.

As the internet, and hence, website access is now widely available on mobile phones and other devices, personalization of communications has become possible as communication language may be created and effected via means of a website, or similar internet interface, made available to user's via to such devices. Project website 1, of FIG. 1, is only one of many examples of a suitable interface that can be used to create personalized language for use via/with communications and/or computing devices, etc.

In FIG. 2, there is shown a preferred communication system 10 which illustrates an embodiment of how user's 12 may interact with the preferred project website 1 shown in FIG. 1, via network(s) 2, utilising any suitable communications and/or computing device(s) 14 (hereinafter simply referred to as “communications device(s) 14”). Although described as being suitable for use via a network(s) 2, it should be understood that system 10 of the present invention is not limited to that use only.

In FIG. 2, it can be seen that project website 1 is hosted by at least one network server 16 which is designed to receive/transmit data from/to at least one communications device 14. The term “communications device 14” refers to any suitable type of computing/communications “device”, or application for same, capable of transmitting/receiving and displaying data as hereinbefore described, as for example, a personal computer or mobile phone, as shown.

Network server 16 is configured to communicate with communications devices 14 via any suitable communications connection or network 2. Communications devices 14 are each configured to display and/or transmit/retrieve data from/to network server 16, or other communications device(s) 14, via network 2. Each communications device 14 may communicate with network server 16, and/or other communications devices 14, via the same or a different network 2. Suitable networks 2 include, but are not limited to: a Local Area Network (LAN); a Personal Area Network (PAN), as for example an Intranet; a Wide Area Network (WAN), as for example the Internet; a Wireless Application Protocol (WAP) network; a Bluetooth network; a satellite network; a radio network; a pager network; a telecommunications network, as for example the recently introduced 3G network; an ISDN network, as for example those regularly used for terminal machines in video conferencing applications; and/or, any suitable WiFi network (wireless network).

Network server 16 may include various types of hardware and/or software necessary for communicating with communications devices 14, as for example routers, switches, access points and/or Internet gateways (all generally referred to by item “18”), each of which would be deemed appropriate by persons skilled in the relevant art.

Communications devices 14 are each configured to be operated by at least one user 12 of system 10. The term “user 12” refers to any person in possession of, or stationed at, at least one communications device 14 whom is able to operate same and transmit/receive data, and/or display/retrieve data from/to network server 16, and/or other communications devices 14, as for example, a mobile phone user readily engaging in text or internet messaging, a web-user readily engaging in e-mail or on-line social network activity, a staff member accessing a company Intranet for e-mail and/or document retrieval or other purposes, and/or any other form of user 12 readily engaging in a form of communication, utilising any suitable software protocol 3, such as, for example, e-mail or SMS as shown in FIGS. 1 & 2.

It will be appreciated that communications devices 14 may also include various types of software and/or hardware required for capturing, sending and/or displaying data for communication purposes including, but not limited to: web-browser or other GUI application(s); monitor(s); GUI pointing devices; and/or, any other suitable data acquisition and/or display device(s) (not shown). Similarly, communications devices 14 may also include various types of software and/or hardware suitable for transmitting/receiving data to/from network server 16, and/or other communications devices 14, via network(s) 2.

Although the use of system 10 is specifically described with reference to users 12 utilising communications devices 14 to connect to, and interact with, network server 16, and/or other communications devices 14, via network 2, it should be appreciated that system 10 of the present invention is not limited to that use only. In an alternative embodiment (not shown) users 12 may simply interact directly with network server 16 which may be their own personal computing device or a public computing device, as for example an Internet kiosk, library or Internet Café computing device(s). In this alternative embodiment, system 10 could be provided entirely by a single network server 16 as a software and/or hardware application(s) and as such communications devices 14 would not be essential to the operation of system 10. The present invention is therefore not limited to the specific arrangement shown in the drawings.

As is shown in FIG. 2, it is preferred that network server 16 is at least one web-server or SMS-server, or is connected via network(s) 2 to at least one additional network server 16 (not shown) acting as a web-server or SMS-server, such that system 10 is an on-line service accessible to users 12 in possession of, or stationed at, communications devices 14 connected to the Internet or a telecommunications network (network(s) 2).

System 10 may be available to users 12 for free, or may be offered to users 12 on an “on demand” Application Service Provider (hereinafter simply referred to as “ASP”) basis, with use thereof being charged accordingly. ASP usage may only apply to a select group of users 12, such as, for example, professional and/or corporate users 12, who may be heavy users of system 10.

It is preferred that network server 16 utilises security to validate access from communications devices 14. It is also preferred that network server 16 performs validation functions to ensure the integrity of data transmitted between network server 16 and communications devices 14. A person skilled in the relevant art will appreciate such technologies and the many options available to achieve a desired level of security and/or data validation, and as such a detailed discussion of same will not be provided. Accordingly, the present invention should be construed as including within its scope any suitable security and/or data validation technologies as would be deemed appropriate by a person skilled in the relevant art.

Communication and/or data transfer between communications devices 14 and network server 16, via network(s) 2, may be achieved utilising any suitable communication and/or data transfer protocol 3, such as, for example, e-mail, SMS, MMS, FTP, Hypertext Transfer Protocol (hereinafter simply referred to as “HTTP”), Transfer Control Protocol/Internet Protocol (hereinafter simply referred to as “TCP/IP”), any suitable Internet based message service, any combination of the preceding protocols and/or technologies, and/or any other suitable protocol or communication technology that allows delivery of data and/or communication/data transfer between communications devices 14 and network server 16.

Access to network server 16, and the transfer of data between communications devices 14 and network server 16, may be intermittently provided (for example, upon request), but is preferably provided “live”, i.e. in real-time.

As already described above, system 10, of FIG. 2, is designed to enable users 12 to create their own personalised language for communication purposes via their communications devices 14, utilising, for example, the project website 1 shown in FIG. 1.

Referring back to FIG. 1, it can be seen that users 12, of system 10 (FIG. 2) are able to interact with project website 1 (hosted by network server 16), via network 2, utilising, for example, SMS or e-mail protocols 3. In this figure it can be seen that project website 1 is designed such that user input data (e.g. commands, captured language, etc) sent/received via data transfer protocol 3 is interpreted and captured by project website 1, as is indicated by block (a) in this figure. Block (b) illustrates that all data captured by project website 1 is stored in an appropriate repository or database(s) 20 (see FIG. 2) for future referral/retrieval purposes. Blocks (c) & (d) illustrate that data and/or any personalised language that is created utilising project website 1 is/are made available to users 12 (in various forms) upon request, or as need be.

To provide a better understanding of the way in which personalized communication language may be created and used by users 12 of system 10, utilising, for example, project website 1 of FIG. 1, reference will now be made to

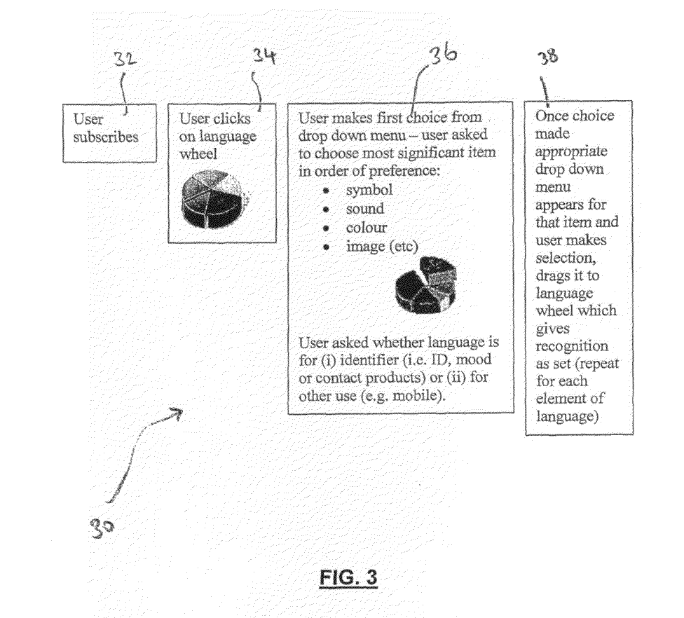

FIG. 3, which illustrates the operation of a preferred language creation module 30 suitable for use with project website 1.

In FIG. 3, it can be seen that in order to create their own personalised language, a user 12 may first need to subscribe to project website 1 as is illustrated by block 32. It will be appreciated that a subscription-based service is not an essential to the operation of the present invention. Accordingly, the present invention should not be construed as limited to the specific example provided. After subscribing, and/or logging-on to project website 1, a user 12 is then free to navigate their way to a language creation page 34 of project website 1, thereafter being ready to create their own personalized communication language in accordance with the invention.

Language may be created for many purposes, including, but not limited to the following purposes: (i) to create a user identifier (i.e. by way of example, an ID crest; mood ring/icon [see FIG. 2 e.g. “mood ring”], and/or a contact icon—as will be discussed in further details below); and/or, (ii) to post language for future use on various platforms on a subscriber's/user's 12 own page of project website 1, or similar website/application (not shown).

On language page 34, available via project website 1 of system 10, a user 12 may be presented with a language wheel (see block 34 of FIG. 3) for the purpose of assisting them with language creation. As is shown in FIG. 3, the language wheel could be a circular (3-dimensional type) icon having various segments each of which represent different types of language for selection by a user 12. A user 12 could then simply click on the segments of the language wheel (block 34) as desired in order to select various types of language elements, which may include, by way of an example only, colours, symbols, images, sound, etc (see block 36 of FIG. 3).

Referring now to blocks 36 & 38 of FIG. 3, upon a user 12 selecting a desired language element, for example “sound”, a drop-down menu of themes may appear for the user 12 to choose from, which may include, by way of an example only, nature, games, adventure, environment, street culture, etc. Each theme preferably has a set number of options, preset as default by system 10, and a user 12 may sample the sounds, if desired, before finally selecting which sound(s) most appeal to them for the particular purpose they desire (e.g. for their ID crest they may choose a favourite sound, whereas for a mood ring/icon they may choose a theme and associated sound that represents how they are currently feeling). After choosing their desired sound(s), a user 12 can then drag and drop that/those sound(s) on the language wheel shown in block 34. Once a/the sound(s) is/are uploaded, the appropriate section/segment of the language wheel may glow (or do otherwise similar) in order to indicate that the relevant segment of the wheel has been ‘set’.

Once a user 12 has defined all the elements of language they wish to define, the user may be prompted to select whether their identifier is for: a social network site such as, for example, Facebook or Myspace; another Application Programming Interface(s) (hereinafter referred to as “API(s)”); and/or, project website 1, or similar. In the case of project website 1, the ID crest may: (i) sit on the user's 12 own page within that website 1; (ii) be used as a reference on a “Direction Page” (a detailed description of same will follow later) of any groups the subscriber/user 12 is a member; and/or, (iii) be used as a reference in any communities the subscriber/user 12 joins. User's 12 may tick/select their answers, and the appropriate icon or options for choice will appear to upload the language thereto. A user 12 may then be prompted to upload their ID crest, etc, to their own page of project website 1, etc.

It will be appreciated that any language created by way of system 10, could be utilized for multiple purposes, as for example, for: creating content to upload to attribute identifiers; for private and confidential communications between selected couplings or groups; and/or, for abbreviating everyday communications via communications devices 14.

When people are getting to know each other they often want abstract symbology that gives room for interpretation. Symbol, etc, that leave things open provide this, creating interest, ongoing contact and a process of discovery.

Personalized language, such as symbols, sounds, and/or other sensory outputs, that can be selected/created for use by way of the method and/or system of the present invention, and/or any associated products, may be incorporated or used in many facets of day to day life, for example, system 10 may provide associated television programs that could use the personalized language created by users 12, or present language, for cross platform branding purposes, etc. Although users 12 may not choose to use the branded symbols (i.e. preset language) offered via system 10, they will be available as options and may act as headers for categories of suggested symbols that are available for use across various platforms.

There are many benefits offered by way of the use of such a multi-sensory and/or multi-faceted personalized language system provided by way of system 10, rather than the use of standard (prior art) text and basic symbols to convey meanings, these include, but are not limited to: the shortening of time required to create a text message, e-mail, etc; the shortening of time to communicate complexity of information; the universality of the language—as symbols, drawings, colour, etc, apply globally, and mostly across all cultural boundaries which will have many cost benefits given that today's communications marketplace is global; and/or, usefulness in sorting information on a communications device 14—e.g. by providing user's 12 with the ability to be able to create their own language via system 10, a user 12 could possibly personalize the navigation (e.g. menus, etc) of their communications devices 14 with their own meaningful language which again gives the user 12 the satisfaction of self expression and builds loyalty to capable communications devices 12 and brands.

Some user's 12 may desire various other forms of sensory interpretation (e.g. vibration or changes in sounds) as a means of expression; other users may want solely visual interpretation. A full five sensory experience could be provided for those such user's 12 by way of system 10, provided of course that their communications devices 14 are capable of relaying those sensory experiences. In accordance with a further aspect of the present invention, such a communications device 14 is intended to be provided by the present invention so that user's 12 have the option to send or cause to be transmitted one or many sensory outputs via a messaging system 10, social network platform 10, or to another capable communications device 14 so that the device 10 or platform upon which the message is received can transmit to the intended recipient a full five sensory experience.

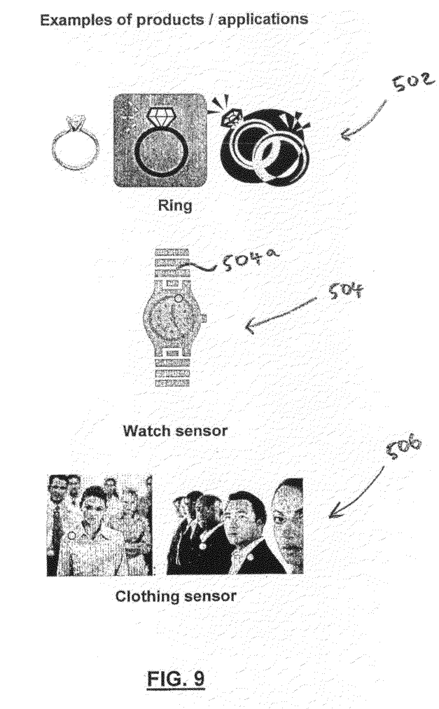

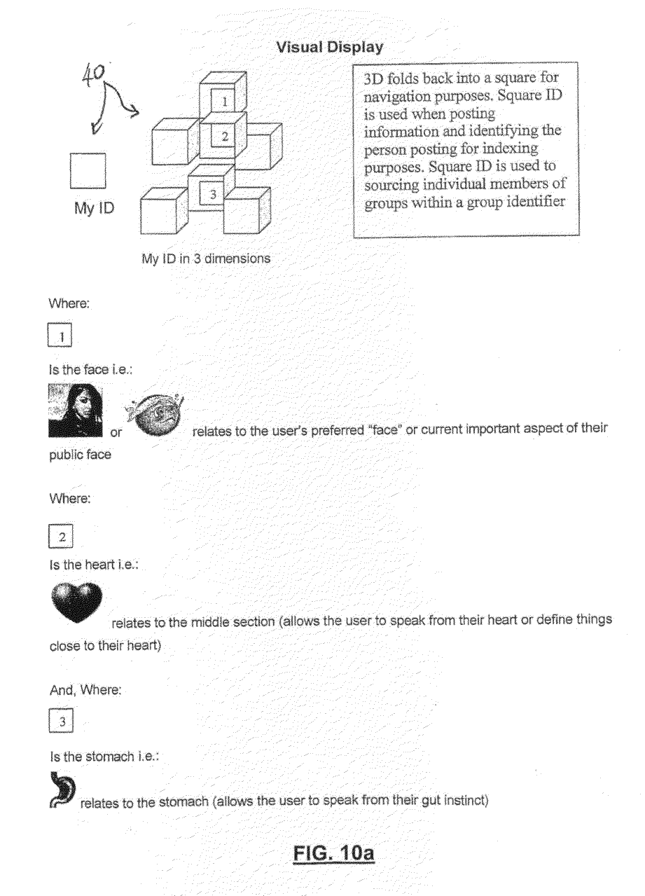

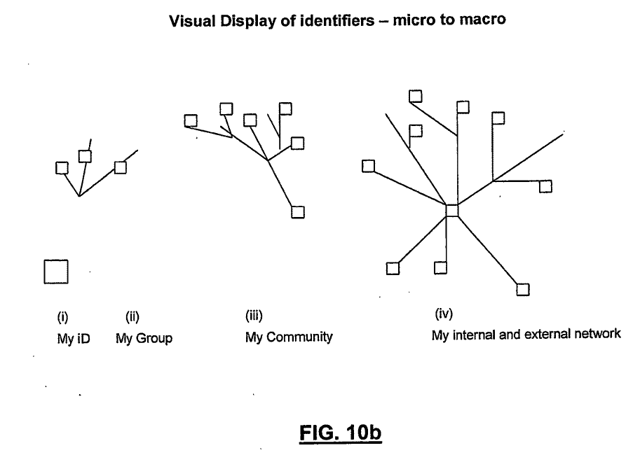

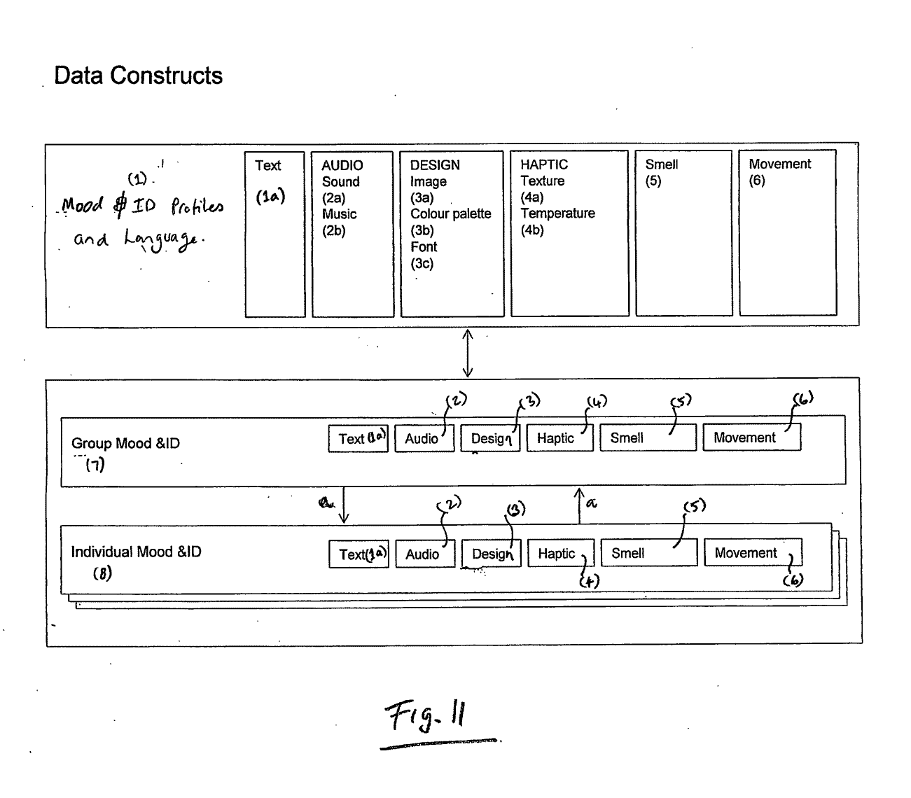

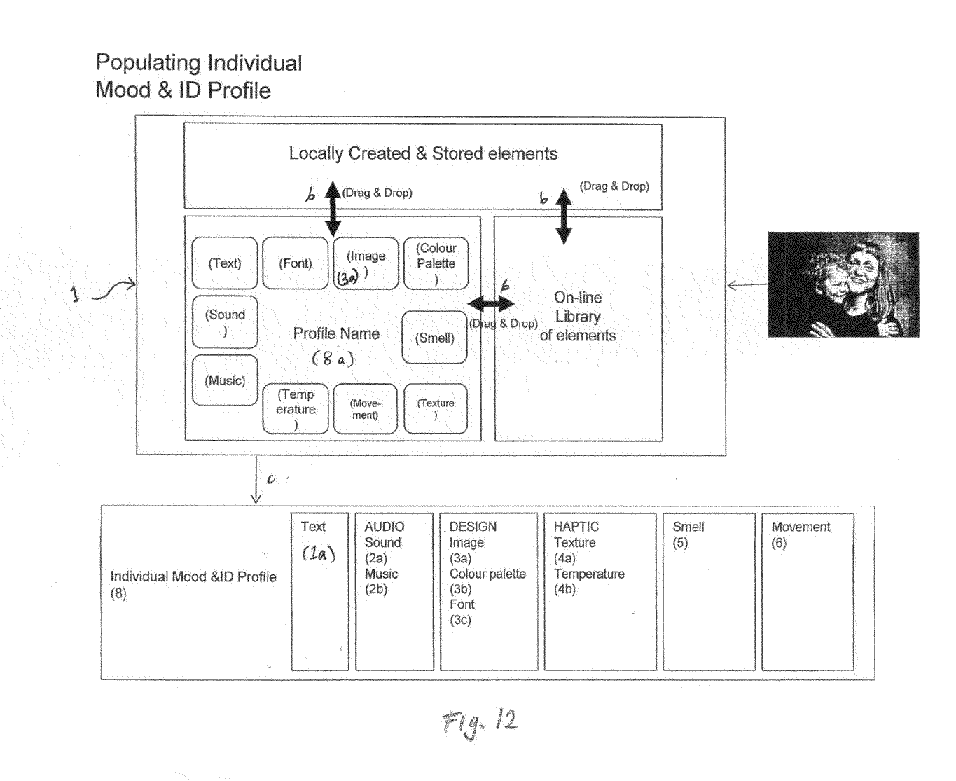

By way of example, it is envisaged within an on-line environment, that the present invention would give users tools to (but not limited to): (i) define multi-faceted identifiers that define: themselves (i.e. by way of example, who they are, what they like, what they stand for); their mood; which part of them is speaking (by way of example, if the user's heart is speaking and connects with this aspect of themselves a heart icon would define this [see, for example, FIG. 10a], or whether the user's head is cognisant of a preference for a particular type of sound that defines them, etc); and/or, the best times to contact them; (ii) create: groups and group identifiers (as described in (i) above); subgroups and subgroup identifiers; multi-sensory language for use within groups and subgroups and for external use on other platforms; and/or, networks and network identifiers; and/or, (iii) utilise created language in other forms such as manufactured products, by way of example, key rings, displays, or other merchandise (see, for example FIG. 9), that is an identifier of the user 12, or promotes the ID and values of a corporation, group, network or organization.

As briefly discussed above with reference to FIGS. 1 to 3, project website 1, of system 10, may also be utilised for the purpose of creating a highly personalized user identifier 40, such as, for example, a ID crest, mood ring or icon (referred to in FIG. 2), and/or, a contact icon.

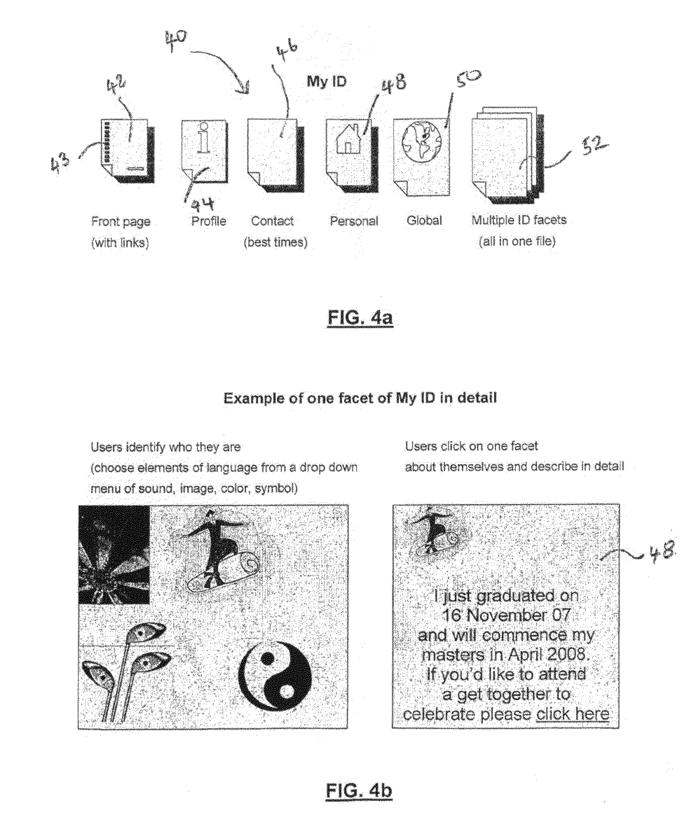

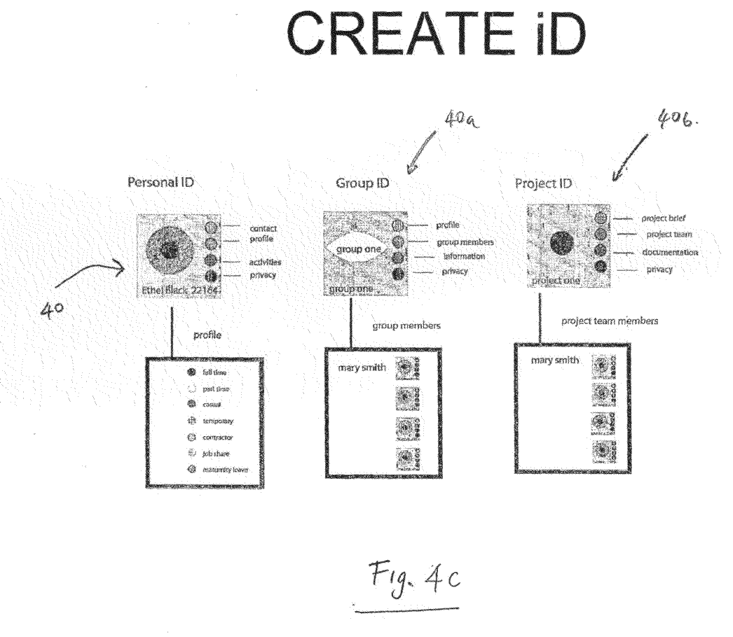

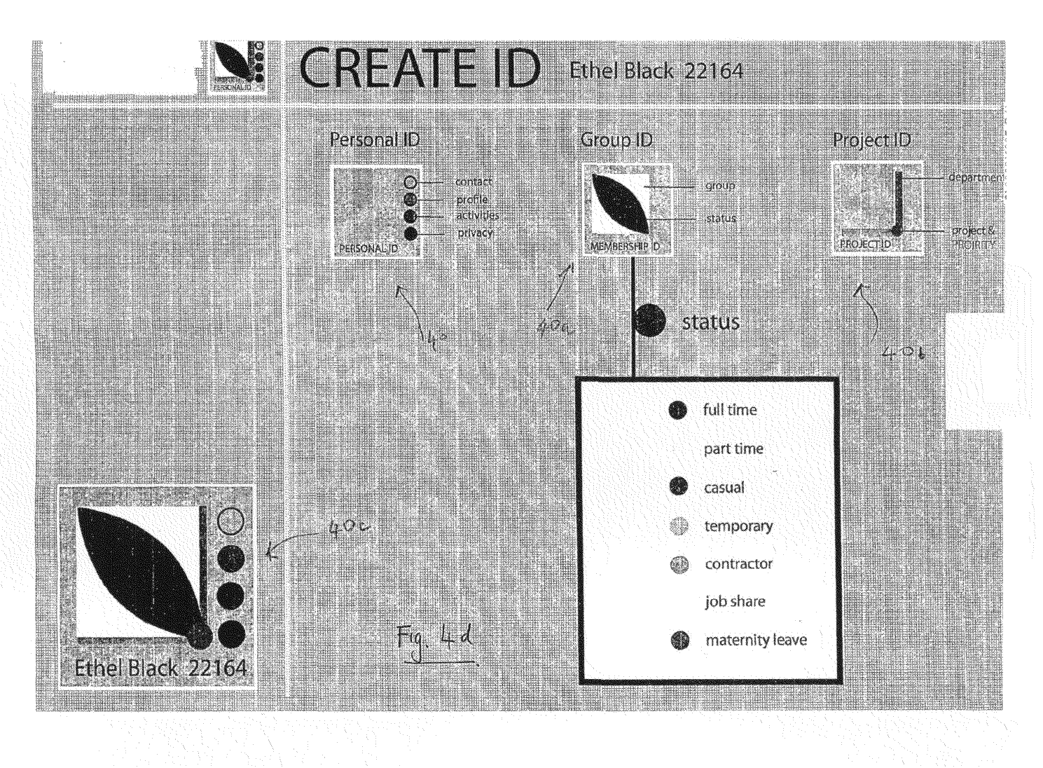

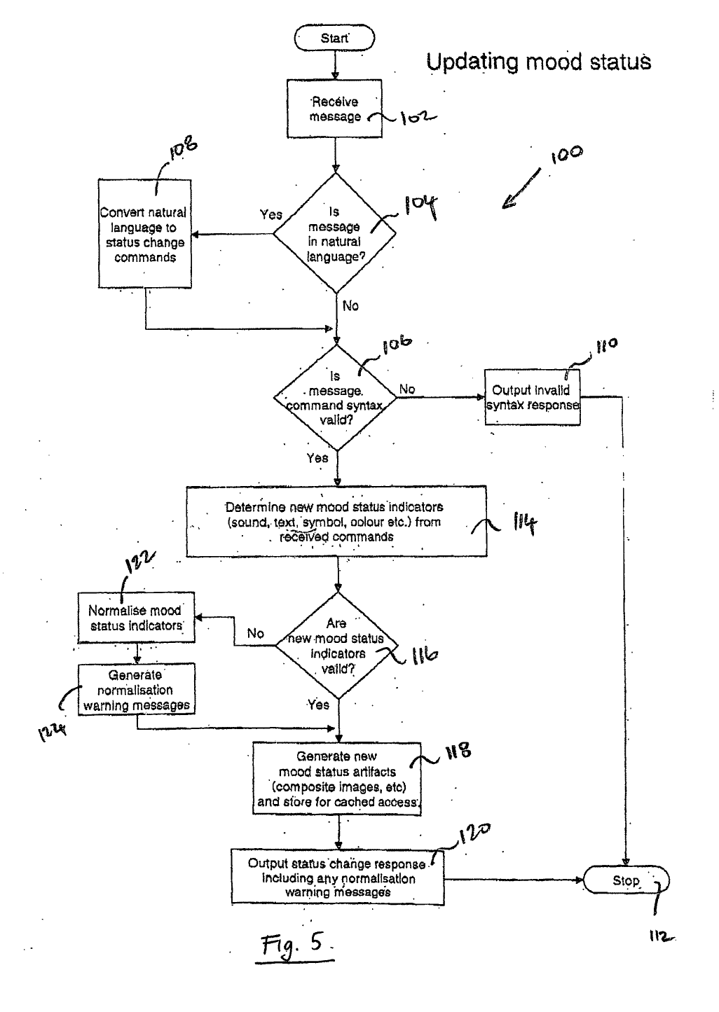

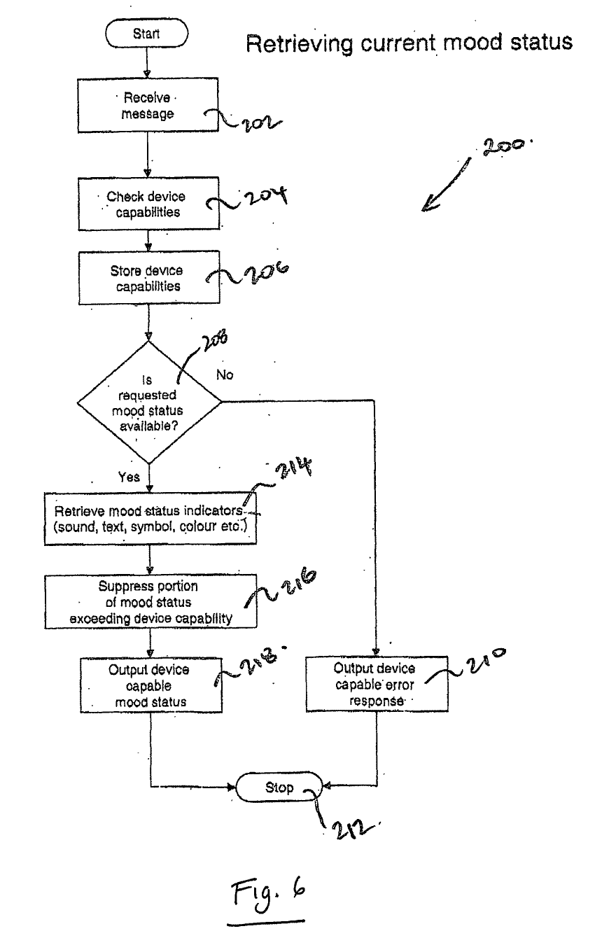

In FIGS. 4a to 4d, various diagrams are provided that each represent a preferred visual display of suitable user identifiers 40, or various facets thereof, that may be created in accordance with system 10 of the present invention. It will be appreciated that these figures are only illustrative of a few examples of the types of user identifiers 40 that can be created in accordance with the present invention. Many other forms of identifiers (not shown) could obviously be provided by way of system 10, and such alternative identifiers are therefore intended to be included within the scope of the present application. By way of example, such user identifiers 40 may be displayed as three dimensional block figures which rotate and/or are animated to display the user's ID, mood and/or present circumstances, etc. A person skilled in the relevant art would appreciate many variations of user identifiers 40, and accordingly the present invention should not be construed as limited to the specific examples provided.

In FIG. 4a, a visual display of a suitable user identifier 40, or user ID, is shown in an exploded view to illustrate the various facets of that identifier 40 that may be accessed independently and stored all in one file. In this figure it can be seen that a user identifier 40 may include a front page 42 with links to other pages or facets of the identifier 40. Suitable other pages/facets include, but are not limited to: a profile page 44; a contact page 46—which could be utilised by a user 12 to, for example, display the best times to contact them; a personal page 48 which could outline various personal attributes or details of a user 12; and/or, a global page 50 that may be used to illustrate a user's 12 friends, groups or networks, etc. In this figure, item 52 is used to illustrate that all facets 42 to 50 of user identifier 40 can be combined and stored in a single file.

FIG. 4b provides an exemplary detailed view of various individual facets that may be stored within a user's identifier 40. More particularly, in this figure it can be seen that by clicking on, for example, the links 43 provided on front page 42, of the identifier 40 shown in FIG. 4a, further information may be accessed, viewed, updated and/or created as desired. The diagram on the left of FIG. 4b shows that user's 12 may create a personal identifier 40 by choosing elements of language by way of, for example, language creation module 30 described above with reference to FIG. 3. Whereas, the diagram of the right of FIG. 4b shows that user's 12 may provide/upload intimate details about themselves, or their current circumstances, which could be included within personal page 48 of the user identifier 40 shown in FIG. 4a.

FIGS. 4c & 4d, are provided to illustrate in more detail preferred visual identifiers 40 that may be created in accordance with system 10 of the present invention. Wherein, in FIG. 4c, it can be seen that a user's personal identifier 40 can be amalgamated within a database 20 of system 10, accessible via project website 1, in order to provide a group identifier 40a (which could be illustrative of all members of a group, community, affiliation, network or organisation), and/or a project specific identifier 40b (which in the case of, for example, a corporation, would be illustrative of all members of a specific project being conducted by that organisation). In FIG. 4c it can also be seen that the front pages of the various identifiers 40,40a,40b, may include various visual indications specific to the user's 12, groups, project, etc. By way of an example, in this figure it can be seen that these preferred identifiers 40,40a,40b, may use colours, symbols, text, etc, in order to visually represent facets of the individuals (user's 12), groups, or project, etc.

FIG. 4d is a similar diagram to that of FIG. 4c, however, in this figure an additional combined identifier 40c is provided as a means of illustrating that the various facets of a personal, group and/or project identifier 40,40a,40b, may be combined by system 10 in order to produce an overlapped visual representation of those identifiers. In this way, for example, the resultant combined identifier 40c is representative of a user's 12 personal, group and project attributes.

FIGS. 4a to 4c, demonstrate that a user 12 of system 10 may create a community (or group), and create a name and identifier 40a (by way of, for example, a check box selection of symbols, etc) for that community. The user 12 may choose to make the community private or public. If it is private, only members (user's 12) of the community would be able to see the ID crests, mood icons, and community mood icons, etc, of the members involved. If it is public, all visitors (user's 12) to the project website 1 would be able to view the members' personal ID crests, mood icons, and the community's mood icons, etc, of the community identifier 40a.

The creator, after having established the community identifier 40a and name, would also be able to send an invitation via a suitable communications protocol 3, such as, for example, via e-mail or via a link to various social networks, or wherever that group of friends or colleagues communicates, to invite them to subscribe to a project website 1, become a member of that community, and define language and their personal ID crest, mood icon, etc, so they can become part of that community. If the community is chosen to be public, members can choose whether the subject matter of their dialogue (identifier 40) relates to direction. If so, they can link to the “Direction Page” of the project website 1 (discussed in detail later in this specification) and in this way widen their exposure and access to members (user's 12) of the wider community with a similar focus or interest.

The community facilitator may set a rating system for the various elements of language and what each element (including colour, etc) means. In this way, community members may contact the group facilitator if they: want to discuss the facilitator's choices; wish to suggest other choices; and/or, wish to post invites for discussion on the community's chosen discussion forum.

As already mentioned above, a community mood icon 40a could be formed by an amalgamation of the various members' individual mood icons (identifiers 40).

Different elements of language (e.g. colour, symbols, images, sounds, etc) could be given a weighting (e.g. out of 1 to 10, depending on the number of options—the number of options being uniform across all elements of language) which will make it easy to amalgamate the members (i.e. user's 12) identifiers 40.

When updated, any old community mood data could be stored in database 20 as a reference and for graphs or displays on the community's own page within project website 1. The old community mood icons, etc, could then be accessed, as required, by clicking on the relevant section of that graph, etc.

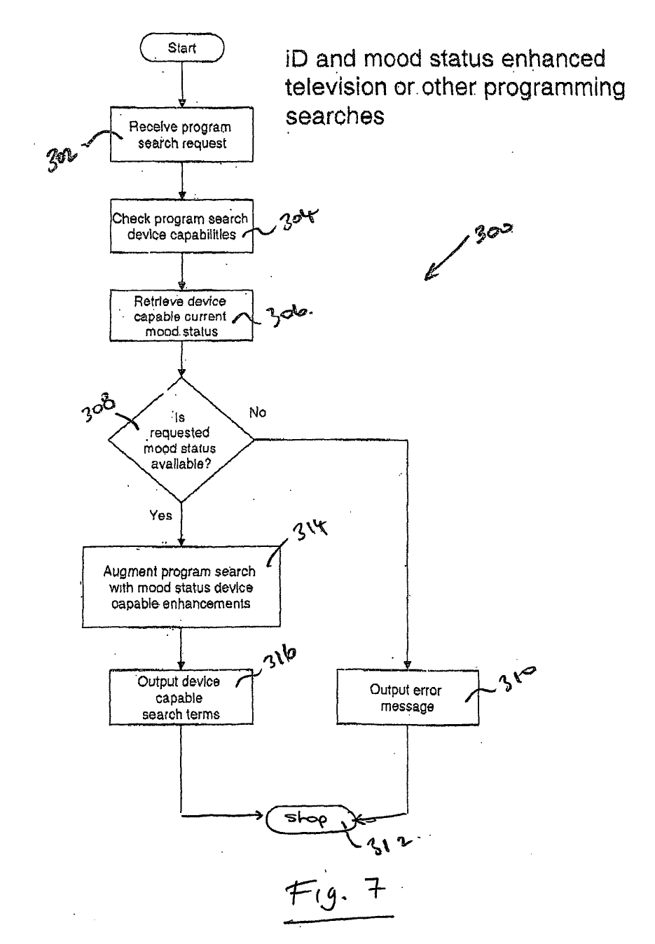

In FIG. 5 there is shown a flow diagram which illustrates a preferred method 100 of updating the mood status of a user identifier 40 in accordance with system 10 of the present invention. Although reference is only made to a preferred method 100 of updating of the mood status of a user identifier 40 in the flow diagram of FIG. 5, it will be appreciated that the same or a similar method (not shown) could also be used to update other attributes/facets of user identifiers 40 in accordance with the present invention.

In this figure it can be seen that in order to update the mood status of a user identifier 40 in accordance with method 100, a user 12 must first send a request to project website 1, of system 10, utilising a suitable communications protocol 3 (e.g. SMS, or e-mail). The request containing, for example, data or words that correspond to the text meanings given to the various elements of language on the site 1. The request signifying the user's 12 circumstances that are to be changed (and also possibly including further details of the user 12 to ensure that system 10 knows who the user 12 is, and/or what they wish to change). The words, etc, contained within the request signifying an emotive word that is referenced at project website 1, as for example, happy, sad, or angry (a user may also select from a set emotional dictionary that corresponds with each element of language). Block 102 of method 100 represents the receipt of that request message by project website 1, of system 10.

At decision block 104, a check may be made to see if the request message contains natural language (obviously other checks could also, or be alternatively, made). If at block 104 it is determined that the request does not contain natural language, method 100 continues at decision block 106 whereat a further check is made to see if the request is readable and/or valid. If at decision block 104 it was determined that the request contained natural language, method 100 continues at block 108 whereat the natural language in the request is converted to a predetermined format representing the status commands necessary to implement the change of mood requested by the user 12. Thereafter, method 100 continues at decision block 106 as before.

At decision block 106 if it is determined that the request is in fact invalid, or contains bad syntax, method 100 continues at block 110 whereat a message is sent to the user 12 to indicate that the requested mood change cannot be performed due to an error, and thereafter method 100 concludes or ends at block 112.

If at decision block 106 it was determined that the request is valid, method 100 continues at block 114 whereat the new mood status indicators are determined from the commands contained within the request.

At decision block 116, yet a further check is performed, this time to see if the new mood status indicators are valid, or allowed, and if they are, at block 118, the new mood status indicators are generated and stored (e.g. in cache, etc) for retrieval. Thereafter, at block 120, an output status change response is generated and sent to the user 12 to indicate that their mood status has been updated and is now available (any associated messages could also be passed onto the user 12 at this stage). Thereafter, method 100 concludes at block 112 as before.

If at decision block 116 it was determined that the new mood indicators are invalid, at block 122 the mood indicators are modified, and at block 124 a message is generated to inform the user 12 of the modifications made to the mood indicators requested. Thereafter, method 100 continues at block 118 as before, and concludes at block 112 after the new mood status indicators are generated and the output response is sent to the user 12 (with the associated message generated at block 124).

Method 100 may require and/or use various status commands in order to update the mood status of a user identifier 40. For example, method 100 could assign the mood status with a set of mappings, and weightings could be made by way of example, as follows: 10=ecstatic—through to 1=depressed.

Each symbol, colour, image, and/or sound offered via project website 1 could be given a number which allows the new updated mood status or icon to be collated according to the numbers each element of language is given.

Users 12 may wish to send mood status updates in abbreviated form and may have this option—e.g. once a user knows the number that each element of language is given they could click on an “abbreviated updates” tab or button (not shown) on project website 1 and then send an SMS, e-mail, etc, in abbreviated form—by way of, for example: C (meaning colour)=1 (i.e. blue); IM (meaning image)=2 (i.e. clouds); SY (meaning symbol)=1 (flat line); and/or, S (meaning sound)=wind.

When a user 12 reorganises a mood icon by sending an update, the intuitive database 20, of system 10, uses the predetermined settings made by the user 12 at the project website 1 to change the mood status or icon of the user identifier 40. The new mood icon is stored on database 20, and may also be referenced as a graph in the users 12 own page within project website 1, and the new current mood status icon is then posted on that user's 12 own page within the website 1. The old mood status data could be stored in database 20 as a reference and for graphs displayed on the user's 12 own page. The old mood status icons would then be available to be accessed by a user 12, by means of clicking on the relevant section of the graph or other visual display within identifier 40.

In accordance with an alternative embodiment (not shown), the present invention may utilise a suitable voice recognition protocol, such as an IVR (interactive voice response box), which could work as a plug-in associated with block 106 of method 100. Such an alternative embodiment would involve voice automated questions and answers which would lead to setting of chosen responses and feed back in order to update the mood status of a user identifier 40.

By means of an example, in order to illustrate that other facets of a user's identifier 40 can also be readily updated by way of a similar method (not shown) to that of method 100 shown in FIG. 5, if we consider the contact part (item 46 in FIG. 4a) of an identifier 40, a user 12 could send a request via a suitable communications protocol (e.g. SMS, email, etc) to project website 1, containing text, words, and/or other data that correspond to the commands required to change the elements of language on the project website 1, that signify the user's 12 circumstances, e.g. busy, frantic, unavailable until . . . ; on holidays until . . . .

Unlike in the case of method 100 for updating the mood status of an identifier 40, a similar method (not shown) of updating of the contact icon (46) of an identifier 40 may not need weightings, as the updates would be literal (i.e. solely text).

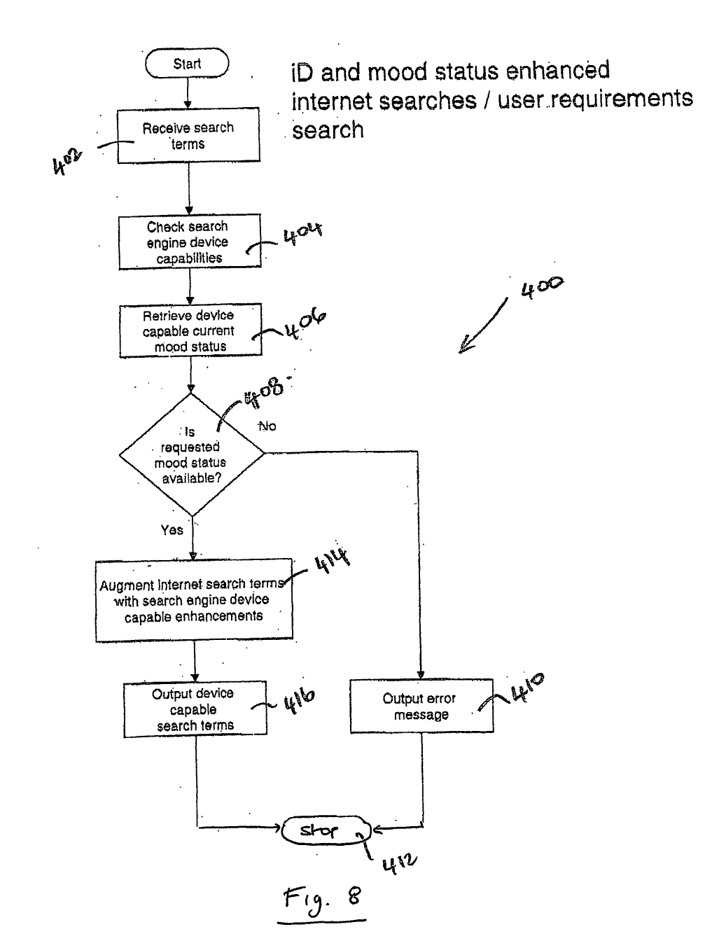

In FIG. 6 there is shown a flow diagram which illustrates a preferred method 200 of retrieving the current mood status of a user identifier 40 in 10, accordance with system 10 of the present invention. Although reference is only made to a preferred method 200 of retrieving the current mood status of a user identifier 40 in the flow diagram of FIG. 6, it will be appreciated that the same or a similar method (not shown) could also be used to retrieve other attributes/facets of user identifiers 40 in accordance with the present invention.

In this figure it can be seen that in order to retrieve the current mood status of a user identifier 40 in accordance with method 200, a user 12 must first send a request to project website 1, of system 10, utilising a suitable communications protocol 3 (e.g. SMS, or e-mail). The request containing, for example, data, words or commands, that correspond to the commands required by project website 1 in order to retrieve the current mood status. Block 202 of method 200 represents the receipt of that request message by project website 1, of system 10.

At block 204, a check may be made to ascertain the user's 12 communications device 14 capabilities for the purpose of providing the current mood status of the relevant identifier 40. At block 206, details of the ascertained device 14 capabilities may be stored for future reference.

At decision block 208 a check is made to see if the requested mood status is available. If at block 208 it is determined that the requested mood status is not available, method 200 continues at block 210 whereat a message is sent to the user 12 to indicate that the requested mood status is not available, and thereafter method 200 concludes or ends at block 212.

If at decision block 208 it was determined that the requested mood status is available, method 200 continues at block 214 whereat the requested mood status is retrieved ready for transmission to the user 12. At block 216 reference is made back to the user's 12 device 14 capabilities stored at block 206 in light of the mood status retrieved at block 214, and if it is determined that the device 14 is limited in its capability to retrieve the entire mood status data, at this block (block 216) the mood status data is modified to suit the user's 12 device 14. Thereafter, at block 218, the resultant mood status data (or original data if no modification was required at block 216) is transmitted to the user 12, and finally, method 200 concludes at block 212 as before.

In FIG. 7 there is shown a flow diagram which illustrates a preferred to method 300 of utilising attributes of a user's identifier 40, for the purpose of conducting an enhanced television, or other programming search. In this figure it can be seen that a user's ID and mood status of an identifier 40 can be used to enhance a television and/or other programming based search. It will be appreciated that other attributes of a user's 12 identifier 40 could alternatively be used for the same purpose. Such an enhanced search facility would be highly suitable for digital TV, video on demand, mobile TV, airline on flight entertainment, etc, where such offerings are now required to be much more personalized then before.

In this figure it can be seen that in order to perform such an enhanced television based search, etc, in accordance with method 300, a user 12 must first send a request to project website 1, of system 10, utilising a suitable communications protocol 3 (e.g. SMS, or e-mail). The request containing, for example, data or words that correspond to the text meanings given to the various elements of language on the site 1, necessary for search purposes. Block 302 of method 300 represents the receipt of that request message by project website 1, etc, of system 10.

At block 304, a check may be made to ascertain the program search communications device 14 capabilities for the purpose of performing the search. Although not shown, like in the case of method 200 shown in FIG. 6, the device 14 capabilities could be stored for future reference.

At block 306 the device 14 capable current mood status is retrieved for the purpose of the enhanced search. At decision block 308 a check is made to see if the requested mood status is available. If at block 308 it is determined that the requested mood status is not available, method 300 continues at block 310 whereat a message is sent to the device 14 to indicate that the requested mood status is not available, and thereafter method 300 concludes or ends at block 312.

If at decision block 308 it was determined that the requested mood status is available, method 300 continues at block 314 whereat the requested mood status is utilised to perform the enhanced program search taking into account the capabilities of the device 14 (determined at block 304). Thereafter, at block 316, the resultant device capable search terms are used to perform the required search, and finally, method 300 concludes at block 312 as before.

The search mechanism used at block 314 could be any suitable searching tool or application, but in accordance with an embodiment of the present invention could be the same or similar to the ‘Search Mechanism 800 ’ referred to later in this specification with reference to Example 18.

In FIG. 8 there is shown a flow diagram which illustrates a preferred method 400 of utilising attributes of a user's identifier 40, for the purpose of conducting an advanced internet search. In this figure it can be seen that a user's ID and mood status of an identifier 40 can be used to perform the advanced search. It will be appreciated that other attributes of a user's 12 identifier 40 could alternatively be used for the same purpose. Such an advanced internet search would significantly enhance a user's 12 experience of searching as there mood, etc, could be used to provide what they are looking for without having to input text each time they perform a search. For any user 12 requirement, a user's ID, mood icon, etc, of their identifier 40 could be utilized to further target and enhance a user's 12 search results.

In this figure it can be seen that in order to perform such an advanced internet search in accordance with method 400, a user 12 must first send a request to project website 1, of system 10, or a search engine (not shown) accessible via network 2, utilising a suitable communications protocol 3 (e.g. SMS, or e-mail). The request containing, for example, data or words that represent the search terms to be used. Block 402 of method 400 represents the receipt of that request message by project website 1, etc, of system 10.

At block 404, a check may be made to ascertain the search engine communications device 14 capabilities for the purpose of performing the requested search. Although not shown, like in the case of method 200 shown in FIG. 6, the device 14 capabilities could be stored for future reference.

At block 406 the device 14 capable current mood status is retrieved for the purpose of the advanced search. At decision block 408 a check is made to see if the requested mood status is available. If at block 408 it is determined that the requested mood status is not available, method 400 continues at block 410 whereat a message is sent to the device 14 to indicate that the requested mood status is not available, and thereafter method 400 concludes or ends at block 412.

If at decision block 408 it was determined that the requested mood status is available, method 400 continues at block 414 whereat the requested mood status is utilised to perform the advanced internet search taking into account the capabilities of the device 14 (determined at block 404). Thereafter, at block 416, the resultant device capable search terms are used to perform the required search, and finally, method 400 concludes at block 412 as before.

Like in the case of method 300 shown in FIG. 7, the search mechanism used at block 414 could be any suitable searching tool or application, but in accordance with an embodiment of the present invention could be the same or similar to the ‘Search Mechanism 800 ’ referred to later in this specification with reference to Example 18.

In FIG. 9 a number of exemplary products and/or devices that may be provided and/or used with any one of the communication methods and/or systems of the present invention are shown. It will be appreciated that the communication products shown in FIG. 9 only represent but a few examples of what will otherwise be considered to be an enormous amount of products suitable for use in accordance with the present invention. The present invention should not be construed as limited to the specific examples provided.

By way of example only, communication products suitable for use with the communication method and/or system of the present invention may include: a ring 502, a watch 504 or a watch band 504a, and/or headgear or other elements attached to, or incorporated within, clothing 506.

Such products or devices could be used in accordance with the present invention to, for example: give a visual display of a user's ID, or other attributes of their identifier 40; alert relevant authorities of an emergency; alert a change in practical circumstance; advise others of an ID change, etc; and/or, advise others of a mood change or update, etc. In other words, such products could be used as physical portable identifiers 40 in order to perform the same or similar functions to that of their electronic or on-line counterparts.

Any of the products 502 to 506, shown in FIG. 9, may change colour, or give off another sensory change according to a user's 12 mood, etc, set at project website 1, and/or via other means of using the method and/or system of communication for updating a user's 12 settings or attributes. An incoming signal would make a change to the ring 502, or other products, in order to demonstrate, and/or visually notify the user 12, and/or other user's 12, of that change. Couples or groups could have rings 502 set so they are co-ordinated—i.e. they may be set to change at the same time according to both/all users 12 moods, etc, and could therefore alert each other of the changes in circumstance, etc. Ring 502, watch 504 (or watch band 504a), or elements within clothing 506, etc, may also be used to display a user's ID, rather than their mood, etc, which may be of use for corporate uniforms, and/or for branding purposes, etc.

FIGS. 10a & 10b are further representations illustrating preferred visual displays relating to individual, group, and/or project identifiers 40,40a,40b. These preferred visual displays being suitable for use with any one of the communication methods and/or systems of the present invention. The preferred identifiers 40 being particularly suited to an indexing system made in accordance with a preferred embodiment of the present invention.

In FIG. 10a it can be seen that a user's 12 identifier 40 can be visually displayed as a 2D or 3D representation. The 2D (or square) representation being suitable for use when, for example, posting of information and identification of that user 12 is required for indexing purposes. The 2D representation also being suitable for use when, for example, sourcing individual members of groups within a group identifier 40a. The 3D representation being readily displayable by way of clicking on the 2D representation when further details regarding a user's 12 identifier 40 are required.

In the case of the 3D representation, it will be seen that block 1 could be used to represent the face of a user 12 (which could be accompanied by a photograph, image, drawing, etc), and in this way the user's 12 preferred face or current important aspect of their public face could be easily viewed. Block 2 could be used to represent the middle section of a user 12, and hence, could be accompanied by a “heart” icon or picture, that would allow a user 12 to demonstrate that they are, for example, speaking from their heart, or defining things close to their heart. Whereas, block 3 could be used to represent other body parts or sections of a user 12, as for example, a user's 12 “stomach”, etc, and hence, could be accompanied by a “stomach” icon or picture, that would allow a user 12 to demonstrate that they are speaking from their gut instinct, etc.

Of course, many other variations of visual displays could be used in accordance with the present invention, and such alternative arrangements are therefore intended to be included within the scope of the present application.

In FIG. 10b a preferred visual display illustrating the way in which groups and/or networks may be created in accordance with any one of the communication methods and/or systems of the present invention is provided. The preferred visual displays, and associated identifiers 40, being particularly suited to an indexing system made in accordance with a preferred embodiment of the present invention.

In this figure it can be seen that identifiers 40,40a,40b, can be displayed in various ways in order to illustrate the way in which groups may be created. In (i) it can be seen that a user's 12 identifier 40 is represented in 2D form on its own. Whilst in (ii) to (iv) it can be seen that a plurality of user's 12 identifiers 40 are interconnected in various ways in order to map, or visually demonstrate, the group (ii), community (iii), and networks (iv) that may be formed or created in accordance with the invention.

As was described above with reference to the creation of community or group identifiers 40a, if a community facilitator chooses to make a community identifier 40a public, other members of that community may choose whether the subject matter of their dialogue (identifier 40) relates to direction. If so, they can link to a “Direction Page” (not shown) of project website 1 and in this way widen their exposure and access to members (user's 12) of the wider community with a similar focus or interest.

On a suitable “Direction Page” (not shown) of project website 1, a user 12 may preferably: (1) see, by way of example, a tree with: (i) various branches that show various directions (e.g. environment, music, street, humanity, sport, etc); and/or, (ii) see community identifiers posted on trees—in this way the tree becomes a giant filing system of easily identified information linked to groups of users 12; (2) click on one of the community icons or other identifiers 40a to go to that community, and link to information and other users 12 in the user's 12 areas to of interest—(each interest group will have a specific icon or other identifier 40a which may have subgroups for further specificity); (3) send a suggestion for a new branch or new interest group and will be able to use their own community page and links until the new interest group is authorised and posted on the “Direction Page”; (4) link back to the language and ID crest pages to define the things the user 12 stands for, or define the symbols for the interest group; (5) use their ID as an icon to navigate and drag to different branches of interest; (6) choose whether they wish to receive information about related: (i) events; (ii) websites of interest; (iii) major issues affecting their community; and/or, (iv) discussion forums for topics of interest; (7) see a glowing light shining (or other visual indicator) on their interest group icon when they have new info or news posted on their “Direction Page” relating to their interest group; and/or, (8) tick one or more boxes to turn off their request for a type(s) of information (as per item 6 above).

Users 12 of such a “Direction Page” will be able to drill down to specific users 12 who belong to the interest group. Users 12 will be able to see the ID crests of those users who have posted their ID crests as “for public viewing”, and link in order to contact directly all interest group members who have chosen public access for their contact details.

In accordance with a further aspect, the present invention may also provide on-line social network users, such as, for example, Facebook users, with the ability to become project users 12 of system 10, as follows (by way of example only): (i) a person may see the project icon, brand or other identifier 40b on a friend's social network page; (ii) that person may then take action to add the project application to their own social network page; (iii) the person hits “add”—which takes the person to a page and asks them to access information—the application is then installed and posted on the person's profile page; (iv) once the person has added the application they get sent to project website 1; (v) they may then be required to complete a registration process in order to use project website 1; (vi) the person then becomes a user 12 of system 10, and can then create language and icons and other identifiers 40 as hereinbefore described; (vii) the user 12 can then update the status of language and icons created on the users 12 own page within project website 1, which is where a subscriber (user 12) can view: (a) their created language and a link to the purpose for which they were created (ID crest, mood icon, contact icon, etc) on the user's 12 own page within project website 1; (b) their ID crest, mood icon, contact icon, etc; (c) communities they are a member of; and, (d) public displays of users' 12 moods, etc; (viii) information is then stored in database 20, and the users 12 profile is updated; and, (ix) icon or identifier 40 featured on another platform such as a social network (e.g. Myspace or Facebook) is posted and updated each time a user's 12 own page within project website 1 is updated.

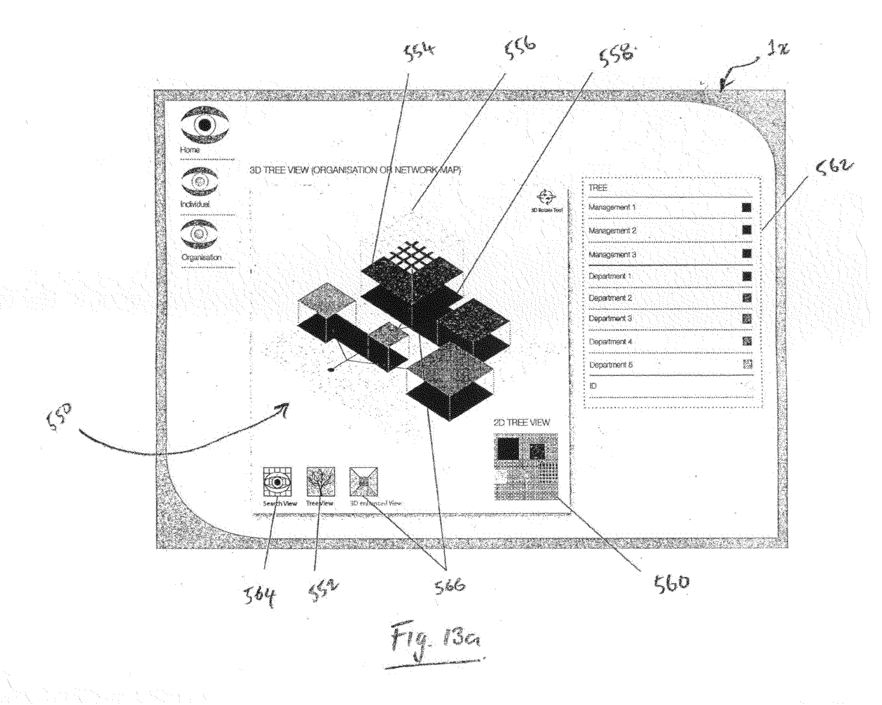

In order to provide a better understanding of the operation of the communication method and/or system of the present invention, a number of examples of possible uses of system 10 will now be described with reference to FIGS. 11 to 23. It should be appreciated that the examples that follow only represent a portion of the possible uses of system 10 and as such the present invention should not be construed as limited to those examples provided.

### Example 1

Person A (12) sends to Person B (12) a text message (“SMS or MMS 3”) from their input terminal or communications device 14 which incorporates both text and image where the image is either one of a choice of options set on the device 14, or created by the sender 12 either on the device 14 or externally and fed back into the device 14—by way of, for example, project website 1.

For example, the first time someone 12 sends a text or other message, the message may be: You make me “ξ”—Where “ξ”=tingle.

The recipient receives the text plus the symbol (i.e. “ξ”). From then on the recipient and sender (user's 12) can communicate using the symbol only, without the text to explain the meaning. In time, and due to knowledge gained by all parties as a result of continued messaging, further abbreviations can occur that are known and recognized by both senders and recipients (user's 12).

This example could apply across all types of communications devices 14, taking into account any technical limitations due to means of delivery, etc.

In FIG. 11 there is shown a block diagram which illustrates various exemplary data constructs that can each be used (on their own, or in combination) in accordance with the (personalized) communication system 10 of the present invention. In this figure, the use of text, images or symbols, as mood and ID profiles, or language, is represented within blocks (1), (7) & (8), by way of sub-blocks: (1a)—e.g. text or character symbols; and, (3a)—e.g. images or picture/complex symbols.

### Example 2

Character strings (i.e. user input) may prompt a recipient's phone, terminal, and/or other communications devices'14 wallpaper to change colour, in order to, for example, support the mood of a sender's message. The wallpaper could obviously be set to reset to the original setting within a predetermined timeframe, i.e. 60 to 90 seconds. The device 14, or device interface 14, may have various settings—e.g. (i) when I send a sad message make the wallpaper on the recipient's phone 14 turn blue; or, (ii) when I send another form of message to a specified person 12 make that recipient's phone 14 turn a specific colour. Users 12 may also be able to utilize and create their own wallpaper within the software application (i.e. within project website 1, or similar application) and then be able to utilize these as wallpaper options in addition to colours, etc.

In FIG. 11, the use of colour, as mood and ID profiles, or language, is represented within blocks (1), (7) & (8), by way of sub-block: (3b)—e.g. colour palette.

### Example 3

When one user 12 sends an image to another user 12 that was inspired by, or based on a sound, partnered or users 12 within a chosen group will on request be able to hear the original sound that inspired the image with a click of a button. Once again, this enhances the process of discovery in the communication process, creates ongoing interest and encourages playfulness amongst users.

In FIG. 11, the use of images and sounds, as mood and ID profiles, or language, is represented within blocks (1), (7) & (8), by way of sub-blocks: (2)—e.g. sound (2a) or music (2b); and, (3a) e.g. images.

### Example 4

Similarly, with groupings, in a social network environment, young people have already, even within the currently available limitations, found a way to express themselves in their own language—be it via abbreviations—e.g. atm (at the moment); lol (laugh out loud); —or via existing symbols such as emoticons provided by providers such as MSN and Skype.

The present invention takes the further step of enabling the user 12 to specifically define with precision their own self-expression. Teenagers and people in their 20's are often in the process of defining who they are and which “clan” they wish to belong to. This invention gives them a useful tool that is in tune with this phase of their lives.

Like in the case of Example 1, in FIG. 11, the use of text, images and symbols, as mood and ID profiles, or language, is represented within blocks (1), (7) & (8), by way of sub-blocks: (1a)—e.g. text or character symbols (e.g. basic smiley faces, etc); and, (3a)—e.g. images or picture/complex symbols (e.g. emoticons).

### Example 5

A user 12, or various users 12, interrelate utilizing project website 1, or other platform where a particular project's content has been posted, or other platform that has licensed the project's content or method, to create a personal ID crest (an identifying crest) or other individual 40, or group identifier 40a, which gives the user 12 a multi-dimensional picture of themselves with which to interact with their friends, colleagues and/or the wider community. The ID crest, or other identifier 40, quickly identifies various facets of the user 12, or community, and enables a user 12, or community, to interrelate more effectively with their network. The ID crest embodies various elements of language defined by the user 12 and posted on their ID crest (identifier 40), including, but not limited to: symbols, images, sounds, colours, etc, that signify meaning to the viewer (user 12) of the ID crest 40.

In this way a vast array of information can be conveyed quickly within the one icon 40, including but not limited to: what the user 12 stands for; what are the user's 12 drivers; what interests the user 12 has; the user's 12 favourite colour; the user's 12 favourite type of music; whether the user 12 is a morning or evening person; what festivals the user 12 likes attending; what interest groups the user 12 is part of, or would like to be part of; whether the user 12 likes change or likes stability; whether the user 12 is social or is a loner; and/or, whether the user 12 wishes to engage locally, nationally or globally.

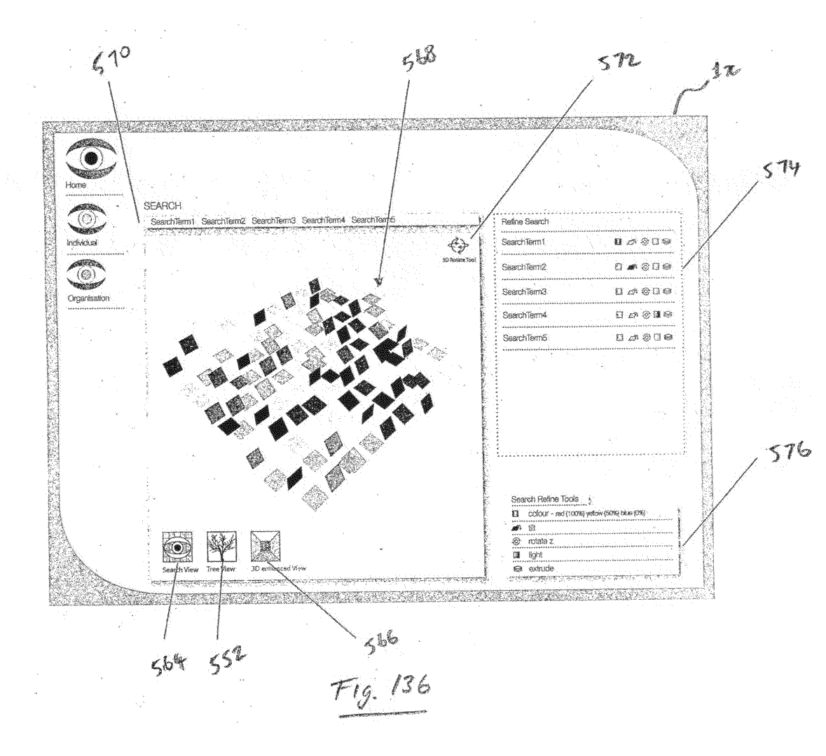

FIG. 12 illustrates an exemplary method or process by way of which individuals may populate there individual Mood and ID Profile (8) with the various data constructs available via system 10, i.e. those shown in FIG. 11. In this figure it can be seen that user's 12 can populate their Profiles (8) utilising project website 1, by way of dragging and dropping (as indicated by arrows b) desired data constructs, e.g. text, images, etc (which may be system installed or user created data elements, as shown), into their profile page (8a) within project website 1, and later transferring same (as indicated by arrow c) to their communications device 14 Profile (8), for use thereafter as a communication language, etc.

### Example 6

The ID crests, or other identifiers 40, created by way of the present invention, could be equally applied into the corporate arena where other types of information about users 12 and groups within the corporation are useful as quick and easy identifiers. All useful and requested information can be easily posted and readily accessed via use of the project website 1, which may enable a corporation to engage and utilize its staff more effectively.

A standard organizational structure is a hierarchy. Very little is known by the people in the lower part of the hierarchy about the plans and operations of the business aside from what their own assigned job is.

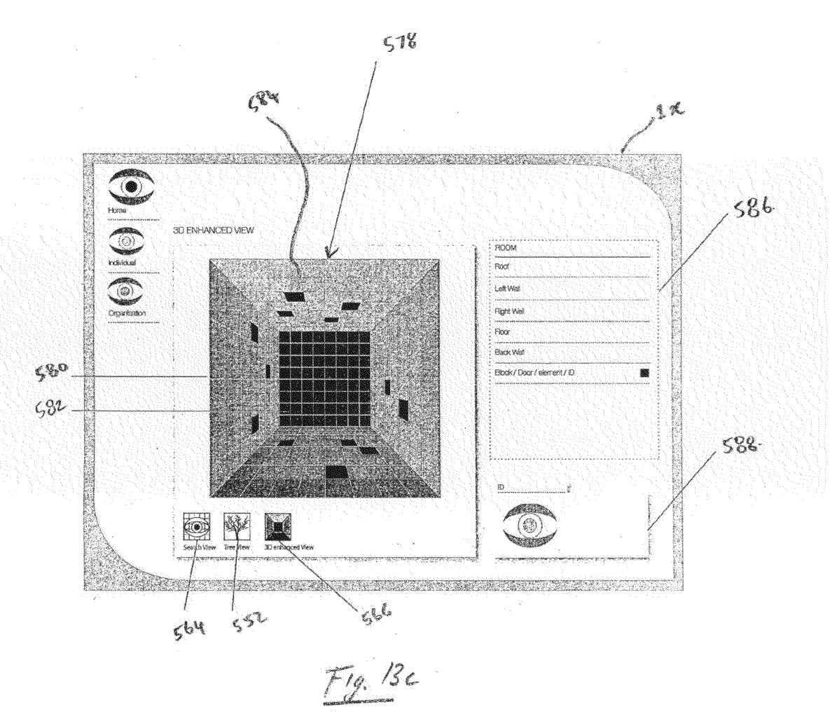

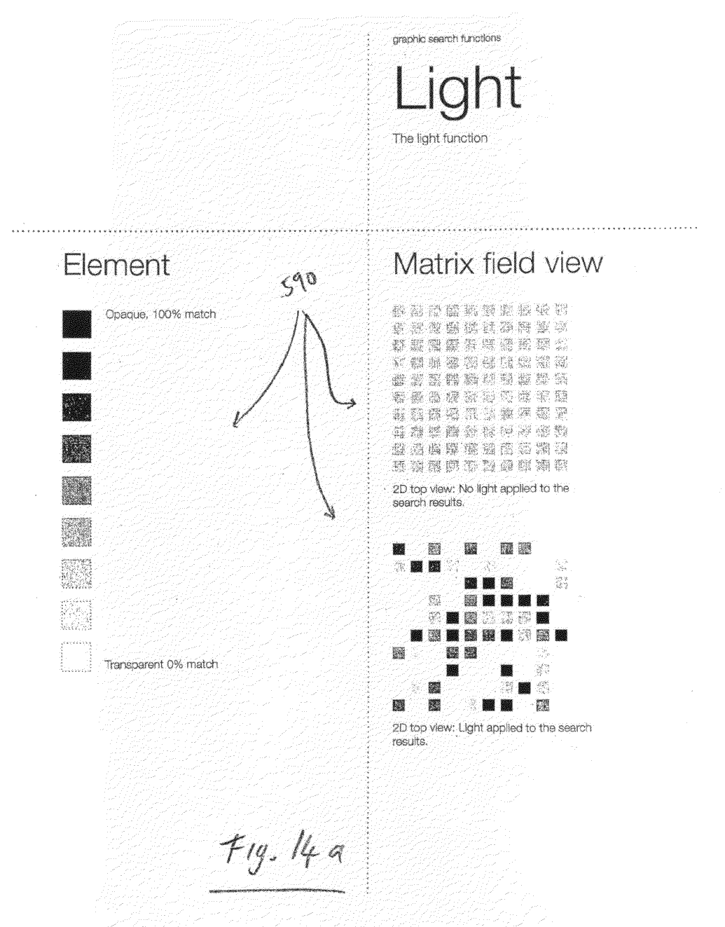

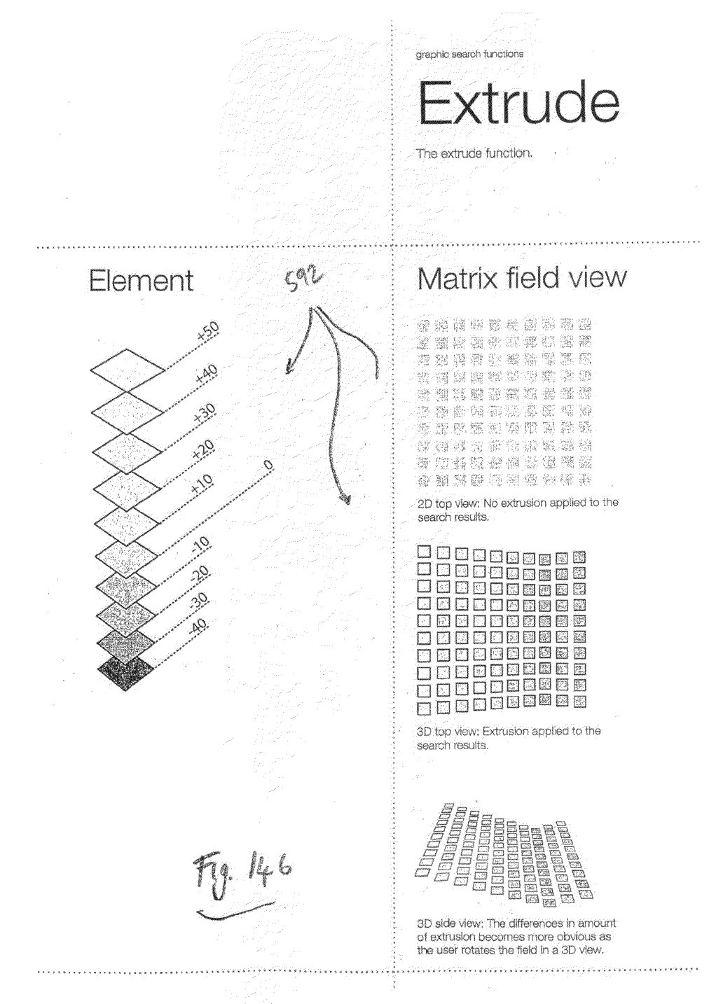

In accordance with yet a further aspect of the present invention, an organization utilizing a project structure and a project's organizational and IT tools may operate instead as a web matrix structure (see FIGS. 13a to 15b) where users and staff members, and their involvement in projects, etc, within the corporation are mapped. Users 12 may organize themselves into project groups which are identified and profiled, and relevant content can be posted where the relevant people can access it. Decisions on who becomes a member, and who can post and distribute content may be self-managed (as directed by guidelines provided by a corporations management, etc).

A corporation could create its own ID (identifier 40) which would feature various aspects of the corporations brand and specific interest or project groups within the corporation. These IDs could then be used to map activities within the corporation.

The ID crest, or other identifier 40, could be utilized across various platforms and adapted for use so as to be suitable to interrelate with users 12 usual methods of communication, and remain readily accessible as a reference at all times.

In FIGS. 13 to 13c various exemplary GUI's 1x (e.g. individual web-pages of project website 1) are provided, which illustrate a preferred embodiment of the way in which the communication method and/or system of the present invention may be utilised within a corporate structure.

More particularly, in these figures it can be seen that various organizational views can be displayed within GUI's 1x for the purpose of visually mapping a corporate organisation, and various facets thereof.

Referring to FIG. 13a, it can be seen that a 3D “Tree View” 550 of an organisation may be displayed within GUI 1x upon a user 12 clicking on a “Tree View” Button 552 provided within the GUI 1x. When selected for display by way of button 552, various aspects or facets of the “Tree View” 550 are visually presented to users 12. For example, item 554 may represent a department within the organisation, whilst item 556 may represent individual IDs (identifiers 40) of individuals within the organisation, and item 558 may represent the management structure underlying the department 554.

In this figure it can also be seen that “Tree View” 550 could alternatively be displayed in 2D form as required (see item 560).

On the right hand side, within GUI 1x, it can be seen that “Tree Panels” 562 may be provided in order to provide feedback to users 12 relating to the particular organisation elements being viewed.

At the bottom of the display, within GUI 1x, along side “Tree View” button 552, it can be seen that additional buttons 564 (namely a “Search View” button) and 566 (namely a “3D Enhanced View” button) may also be provided in order to switch to the additional organizational views shown in FIGS. 13b & 13c.

In FIG. 13b, it can be seen a 3D matrix-type “Search View” 568 of an organisation may be displayed within GUI 1x upon a user 12 clicking on a “Search View” Button 564, provided within the GUI 1x. This “Search View” 568 being a visual representation of retrieved organizational attributes or individuals, departments, etc, after an organisation search has been performed by way of entering search terms into the “Search” field 570 provided at the top left corner of the “Search View” 568 display.

In order to enhance the 3D “Search View” 568, and/or to improve the interactivity within this GUI 1x, a “Rotate View” button or icon 572 may be provided, for example, at the top right corner of the “Search View” 568 screen. Such a “Rotate View” button 572 would enable users 12 to readily rotate the display, as need be, in order to highlight and more clearly reveal the various relationships (elements, etc) illustrated by way of this “Search View” 568 display.

On the right hand side, within GUI 1x, it can be seen that “Refine Search” fields 574 may be provided in order to enable users 12 to refine their organizational search, and hence, the resultant “Search View” 568 displayed within GUI 1x. To assist users with understanding the search tools provided, at the bottom right hand side, within GUI 1x, it can be seen that a “Search Refine Tools” legend 576 may be provided for in order to describe the icons, etc, that may be used for search purposes.

In FIG. 13c, it can be seen a 3D “Enhanced View” 578 of an organisation may be displayed within GUI 1x upon a user 12 clicking on a “3D Enhanced View” Button 566, provided within the GUI 1x. This “Enhanced View” 578 being a visual representation of an organisation by way of, for example, a room having 5 different walls, i.e. a roof, left wall, right wall, back wall, and floor, as shown.

The front of the ‘room’ being indicated by item 580, and the back of the ‘room’, or back wall, being indicated by item 582.

The ‘black blocks’ 584 shown within “Enhanced View” 578 may have multiple uses, such as, for example, they may indicate: links to other rooms, matrices, search result sets, documents, and/or groups of documents. These ‘black blocks’ 584 may be enabled and organised as desired by users 12 of system 10.

On the right hand side, within GUI 1x, it can be seen that “Room Panels” 586 may be provided in order to give users 12 feedback about the walls and elements being viewed within GUI 1x. Similarly, in order to further assist users 12 with understanding the elements and/or ID's displayed within GUI 1x, an “ID Panel” 588 may be provided in the bottom right hand side of the display for providing the relevant feedback information.

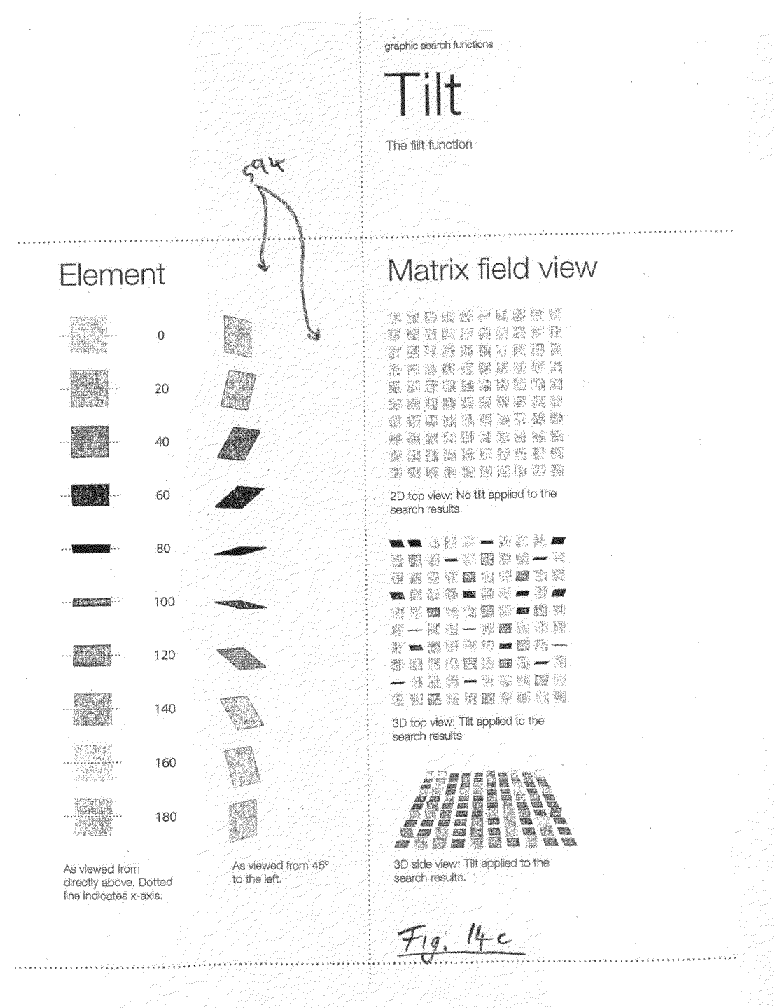

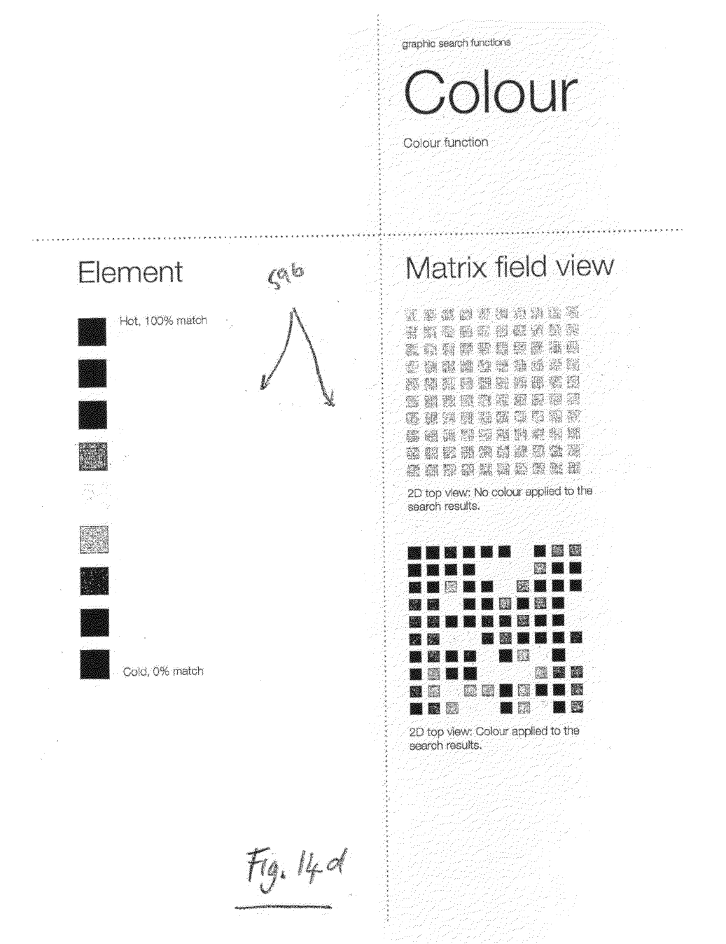

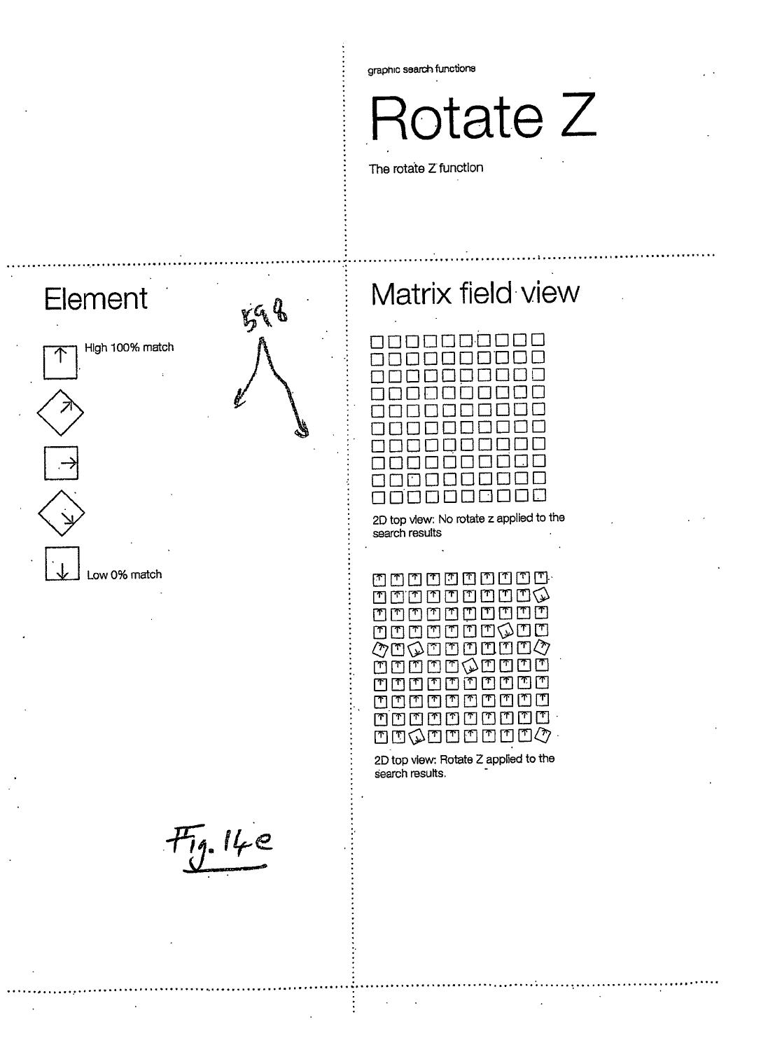

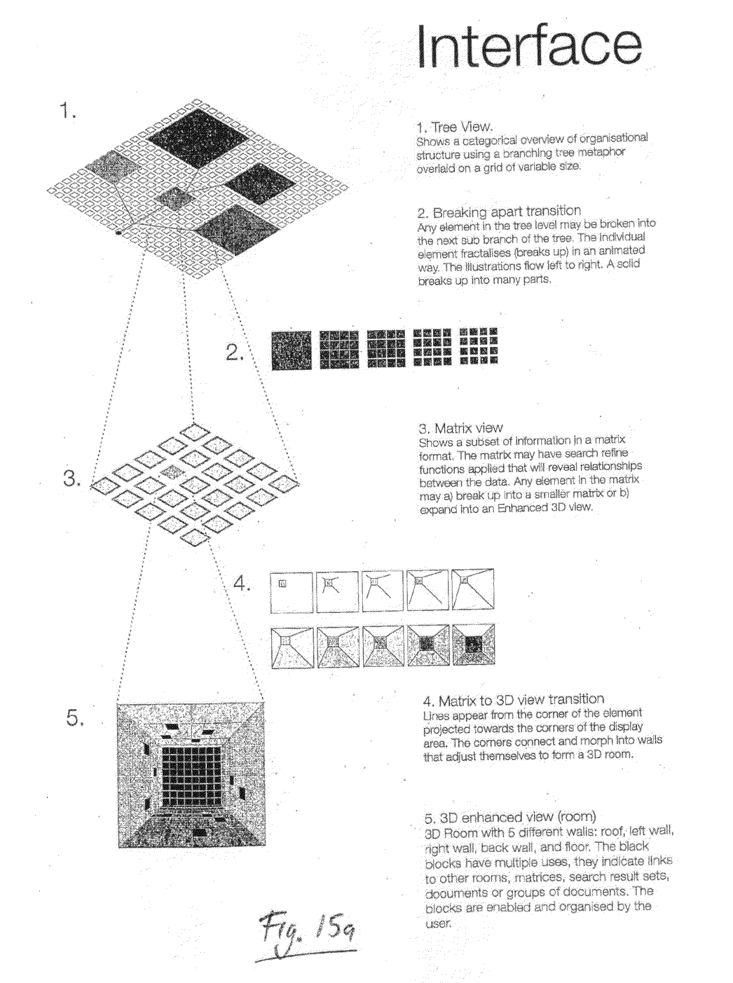

In FIGS. 14a to 14d various diagrams are provided in order to illustrate in detail the individual exemplary elements that may be used within the preferred

GUI's 1x shown in FIGS. 13a to 13c. Namely in FIG. 14a, various functions of “Light” elements 590 are illustrated to demonstrate how variations in brightness, contrast, etc, of these elements can be used to express different modes or attributes. The Light function works with transparency and brightness. Relevant results are more opaque, irrelevant results are more transparent, making them disappear. In FIG. 14b, various functions of “Extrude” elements 592 are illustrated to demonstrate how variations in angles, shading, etc, of these elements can be used to express different attributes. The Extrude Function raises or lowers elements from their origin along the Z axis. By way of example, the height raised indicates the degree of relevance and the height lowered may be set to indicate the degree of irrelevance. In FIG. 14c, various functions of “Tilt” elements 594 are illustrated to demonstrate how variations in angles, etc, of these elements can be used to express different attributes. Tilt is a rotation of an element on its x axis. The range of available tilting is 0-180 degrees but may be more limited depending on user requirements and giving due consideration to optimising the best delivery of functionality and readability, taking into account differences due to the variances in visual delivery software (e.g.: 3D or Flash software). The graphical effect of tilting is influenced by both the angle of the view and how light reflects the element. In FIG. 14d, various functions of “Colour” elements 596 are illustrated to demonstrate how variations in colour, etc, of these elements can be used to express different attributes. Colour tinting of an element is used to indicate the relevance of a search item or as colour becomes darker the heaviness or quantity of the search result. Colours can be user defined but default settings are graduated from red to yellow to blue. By way of example, red indicates hot or high relevance and blue indicates a cold or low relevance. And finally, in FIG. 14e, various functions of “Rotate Z” elements 598 are illustrated to demonstrate how variations in rotation, orientation, etc, of these elements can be used to express different attributes. Rotation of an element is on its z axis. The range of available tilting is 0-180 degrees but may be more limited depending on user requirements and giving due consideration to optimising the best delivery of functionality and readability taking into account differences due to the variances in visual delivery software (eg: 3D or Flash software). The graphical effect of rotation highlights elements by placing them at differing angles to each other and any elements out of line are quickly identified. All graphic function settings may be customised by the user.

It will be appreciated that the specific elements 590 to 598 shown in FIGS. 14a to 14e only represent examples of suitable elements that may be used in accordance with communication system 10 of the present invention. A person skilled in the art would appreciate many variations, and as such, the invention should not be construed as limited to the specific examples provided.

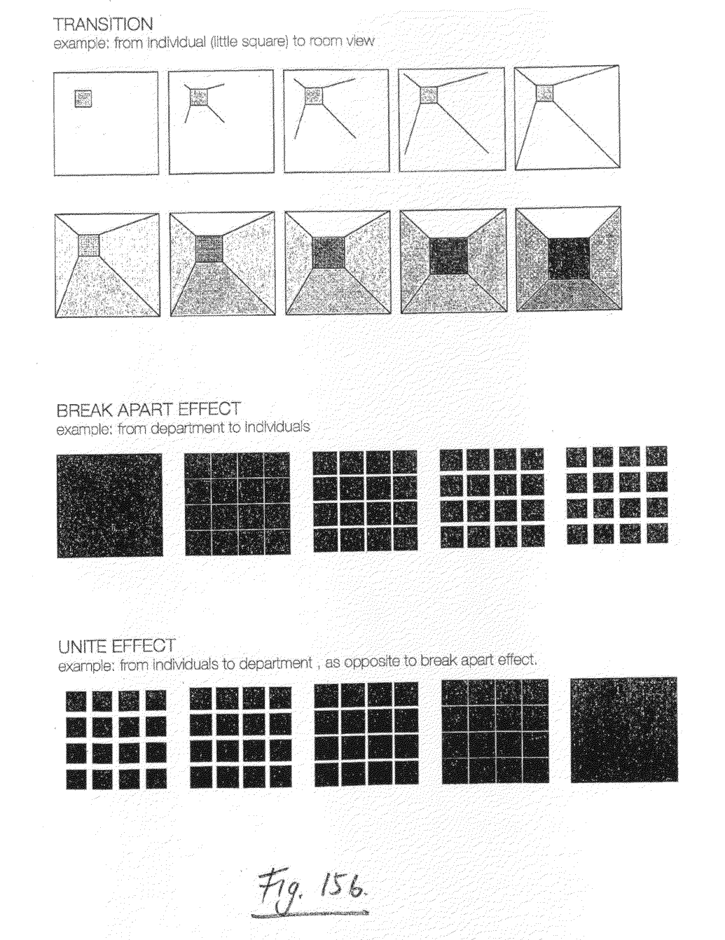

FIGS. 15a & 15b are provided in order illustrate in detail the available views, and transition or break-away effects, that may be provided, by way of example only, for use within the preferred (corporate type) organizational visual displays shown in GUI's 1x of FIGS. 13a to 13c. Like before, as described with reference to the example elements shown in FIGS. 14a to 14e, the present invention should not be construed as limited to the specific examples provided.

In terms of the actual or type of organizational searches, etc, that may be performed by way of utilising the “Search” field 570 provided within GUI 1x of the “Search View” 568 display of FIG. 13b, it will be appreciated that many options are available. Any suitable search mechanism could be used (for example that described below in accordance with Example 17), including existing search engine applications.

The visual display of results within, for example, “Search View” 568 of FIG. 13b, may make use of a number of dimensions of the search results obtained. Each dimension may relate to a categorization of information based on one or a combination of meta-data attributes of the objects being searched.

The visual representation seeks to represent the categories via a three spatial dimensional depiction of the range of categories. Each category being represented via a symbol or icon laid out in an arrangement so that all categories can be easily seen.

Each keyword that is being used for the search will result in a visual quality being applied to a category symbol such that a user 12 can distinguish the relative strength of the search matches within that category by the quality. Qualities may be visual, audial, or some other sense that can be represented is through a computer interface 14. For example, the inclination to the plane (“Tilt”) of the symbol, or tile, can provide an indication of the relative number of matches within a given category. Other qualities may include orientation to other symbols, colour strength, glow, or any other visual use that would enable a user to differentiate between various categories.

Each quality may be applied to each category symbol at the same time. For example, if three keywords are included in the search, three different qualities would be used on each symbol to indicate the relative size of the results for each keyword. Thus a user 12 is able to distinguish which of the categories contains the largest number of ‘matches’ for any single keyword or any combination of keywords.

The user 12 is able to select a specific category of interest and drill-down to a lower level of detail within that category until the arrive at a level where each symbol depicts an individual object, such as, for example, a document or a person record, or some other object. The user 12 is also able to change the attributes (or set of categories) to base the visual depiction on the results obtained. For example, the initial display may use organization unit or department to view categories which may be changed to an age categorization. The visual cues or qualities would be recalculated (or use a pre-calculated date) to change the display of the qualities as there may be a different distribution of results in the different category dimension.

When the search results return individual objects representing documents, or person records, or other objects, the qualities may be associated with the specific relevance rating for that object as it relates to each keyword. The mechanism for determining the relevance rating may be the same mechanism as used in the search mechanism or it may be some mechanism as used by other available search engines such as Google, Yahoo, etc.

### Example 7

Language created in accordance with the communication method and/or system of the present invention could be utilised by a bio-feedback device, proximity sensory, badge, keycard, etc, in order to personalize a physical environment.

In the case of a bio-feedback device, such a device could be placed on a user's 12 fingers to measure their response to certain questions and types of languages, etc. This process may occur, by way of example: via a games console; via a game that is loaded onto a mobile device 14; via a game that can be downloaded to a mobile device 14; and/or, by a mobile or handheld games device 14 that has the capability to interface with other devices 14. It is envisaged that the language that is created or attributed to the user via the bio-feedback device, in accordance with the invention, will be able to be used as language for use on mobile phones, other equipment, and/or devices 14.

In the case of a proximity device, such a device could be worn by users 12 in order to remotely activate various communications devices 14 when in the vicinity thereof. In this way, personal attributes stored on the proximity device could instruct devices in the vicinity of the user 12 to change settings, etc, based on that users 12 mood, current situation, etc.

In the case of a home or building automation system, the Mood & ID Language data stored on a proximity or similar device could be used to control environmental factors in the home or building including lighting, temperature, smell, music, images, etc.

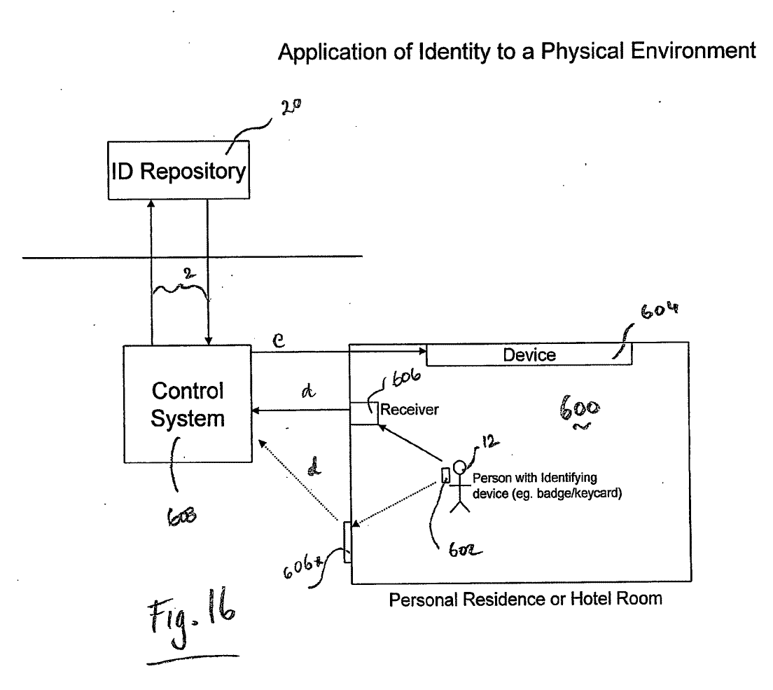

In FIG. 16, a block diagram is shown which illustrates how a user's 12 personal ID profile can be applied to a physical environment 600 in accordance with yet a further preferred aspect of the present invention.

In this figure it can be seen that a user 12 is in possession of, for example, a proximity base (or otherwise) badge or key-card device 602, which stores their personal ID profile 40 in accordance with the invention. The possession of such a personal ID device 602 may enable the user 12 to remotely control devices 604 within that physical environment 600, as follows: (i) the presence of a user 12 (or group of user's 12—not shown) is sensed within physical location 600 by way of a receiver/transmitter, or transceiver 606, or a series of such devices 606, when the proximity based device 602 is within range of same (i.e. transceiver(s) 606); (ii) upon detecting the presence of the user 12 within environment 600, the personal identifier 40 information is (stored on proximity device 602) is relayed to a control system 608 by way of transceiver(s) 606, as is indicated by arrows d—this could be accomplished by any form of wired or wireless connection; (iii) control system 608 then communicates via a network 2 (e.g. the internet) with the ID repository (database 20) provided by network server 16 of system 10—it is preferred that the communication between control system 608 and ID repository 20 is established via the use of an encrypted channel using standard internet based security protocols (such as SSL, etc)—control system 608 passes the user's 12 personal identifier 40 to ID repository 20 in the form of a query or request; (iv) ID repository 20 provides a response to control system 608, via network 2, this response including the characteristics or attributes of the user 12 stored within the repository 20—the user's 12 attributes are used as a basis object for querying the control system 608 settings using a suitable search mechanism—the object of the query being to ascertain one or more objects which can be used to determine the configuration of the environment 600, such a query returning the matching device settings for application to the environment 600, for example, the temperature setting of the thermostat 604, the music to be played via a music device 604, and/or the configuration of the curtains within the room 600 are potential settings that may be returned (the specific settings that are queried are dependent upon the capability and configuration of the specific environment 600); and, (vi) control system 608 then relays commands to the relevant device(s) 604 within physical environment 600 for the purpose of the configuration of same, as is indicated by arrow e.

It will be appreciated that physical environment 600 could be room within a personal residence, apartment, hotel, etc, and/or any other location where the presence of a user 12 may be determined in accordance with the invention as hereinbefore described. Similarly, the sensing of the presence of a user 12 within environment 600 maybe achieved via any suitable means, as for example, a badge device 602 geared to communication by RF with a transceiver 606, or a key-card device 602 required to be swiped through a door entry system (i.e. transceiver 606x in FIG. 16).

The invention therefore provides opportunities for users 12 to interactively personalize equipment, appliances and/or other home-ware items 604 that are adapted for use with the system described, so that users 12 can more fully personalize their home environment 600 with the use of their chosen language (identifier 40) and personalize their environment with their own chosen textures, smells, colours, symbols, and/or other elements of language, etc.

In an alternative arrangement (not shown), in the case of a particular hotel, a user 12 may be able to visit that hotels project page within project website 1 in order to pre-advise that hotel of their personal attributes, etc. In this way, the hotel would receive advanced notice of a user's 12 ID, mood, etc, such that they could then set all settings within the user's 12 hotel room according to those settings.

### Example 8

Language created in accordance with system 10 of the present invention may be determined by a game, whereby the game user 12 may be asked a set of questions which determines a user's identifying characteristics to be able to be posted into their ID crest, mood icon, and/or other identifying product (identifier 40), that provides a means of quick and effective identification of the user 12 on multiple levels.

The game, via its series of questions and responses regarding the user 12, may also attribute a set of language elements for that user 12 so that they can later be used as language for use on mobile phones and/or other devices 14. This process may occur via a games console 14, via a game that is loaded on a mobile device 14, via a game that can be downloaded to a mobile device 14, or by a mobile or handheld games device 14 that has the capability to interface with other devices 14. The language that is created or attributed to the user 12 via the game will be able to used as language for use on mobile phones and/or other equipment or devices 14.

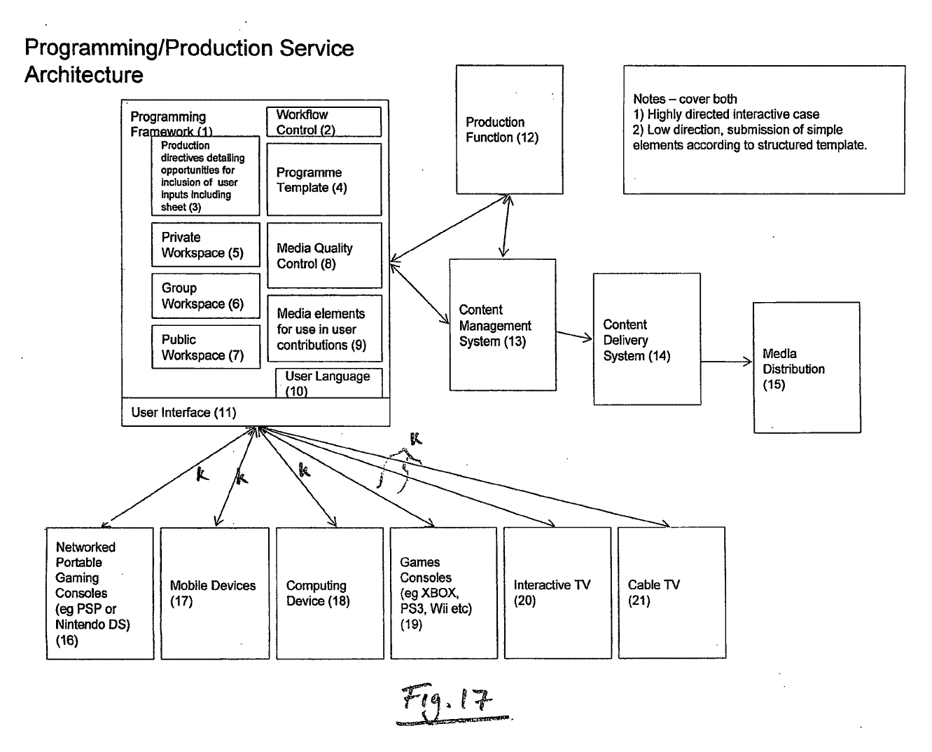

By way of an example, reference will now be made to FIG. 17 which contains a block diagram that illustrates how various programming and/or production services (e.g. a games consoles, etc, as referred to by block 19) may interact and be used in accordance with yet a further preferred embodiment of a communication method and/or system of the present invention. In the context of this example, a user “T” whom is a “gamer” will be referred to with reference to FIG. 17. User T is a member of the Group Workspace (block 6) for G United.

User T has reviewed the various games templates within the Programming Template (block 4) and posts a suggestion at the Group Workspace (block 6) to create a new game based on his friends experience on the weekend where they captured a lot of files in a fun environment.

There is wide enthusiasm and a further user “S” is appointed group moderator of the new game WYde. Given his/her higher access user S accesses the media elements for the game (block 9), becomes project manager for the game based on the Production Directives (block 3), and the interested users continue with the process of gathering language for insertion into the game. A new game is written based on the production directives (block 3) and the users' 12 language. The users' 12 language is filtered through the media control system (block 8) for suitability. The final submission is then sent by User S to the Production Function (block 12) for approval, and once approved, is sent back to the user interface (block 11), and finally published on games consoles and/or computing devices (blocks 18 and/or 19).

### Example 9

A sender (user 12) sends a dog barking sound via their phone 14 to another user 12, the sender 12 chooses whether to send the actual bark or a visual depiction of the bark, or even a picture related to the bark that describes the sender's intention. If the recipient 12 is the sender's 12 partner they will know if the dog barking means “come home I miss you”, or “you're in the dog house”—this abstract expression gives personality to the users' 12 regular means of communication and a degree of intimacy—i.e. only the couples know what that language means—since we are now all so time short this offers the user an opportunity to quickly say to their partner “I know what you like”, or “I′m in tune with you” within a very short time frame and in a quirky, fun way.

In FIG. 11, the use of sounds, images, and text or symbols, as mood and ID profiles, or language, is represented within blocks (1), (7) & (8), by way of sub-blocks: (1a)—e.g. text; (2)—e.g. sound (2a) or music (2b); and, (3a) e.g. images or pictures.

### Example 10

A user 12 sends a message to their station or user login at project website 1, or other place where the project's content is posted for use, which fixes settings and interfaces with all the users' 12 future incoming e-mails, or other communications 3, for that day or other time period. Other users 12 who interact with the first user 12 are advised of the first user's 12 mood, level of busyness, and/or any other information the first user 12 wishes to specify, so that they are aware of such conditions before communicating with the first user 12. The settings can be changed by the first user 12 throughout the day as the first user's 12 mood and level of busyness, etc, change.

In this way, people seeking to contact the first user 12 will have an awareness of the first user's 12 mood and circumstances, which will provide for more effective communication.

### Example 11

User's 12 may be provided with options to personalize communications and interactively create their own language for use across communications devices 14 (and any other forms of equipment) that allow for user 12 personalization. This would provide opportunities for corporations and their staff to interactively personalize equipment and interfaces with equipment, work and retail environments. This may facilitate ease and efficiency of use of language and interaction, reinforce a company's branding, and/or allow for staff involvement in the creation of the company's language for use within the corporation.

It will be appreciated that this preferred embodiment could be incorporated into the exemplary corporation based operational structures shown in the GUI's 1x of FIGS. 13a to 13c.

### Example 12

The communication system 10 of the present invention may operate to give a corporation's staff (user's 12) the tools to define their mood, and the corporation the opportunity to utilize data, taken from a history of their staffs mood over a certain time period, to incorporate into employee satisfaction surveys, etc. This could, for example, operate as a ‘real time’ employee to satisfaction survey using the project's tools which may enable: (i) identifying characteristics about each staff member to be determined; and, (ii) each staff member's mood to be conveyed in the moment and collated later for the survey's purpose.

The data collected using this method and system to create the mood icons, etc, could be utilized to create such reports for corporations. Previous mood icons could be stored in a type of time capsule such that corporations can view a user's mood history and context as desired.

It will be appreciated that this preferred embodiment could be incorporated into the exemplary corporation based operational structures shown in the GUI's 1x of FIGS. 13a to 13c.

### Example 13

A sender creates a snippet of a karaoke message on project website 1, or other platform where the project's content is posted, or the project's method is licensed for use, for interactive use as a means of communication. The website 1, other platform, or a database stores various snippets of backing tracks which are compartmentalized at various levels of difficulty, and various sounds which a user 12 may use to create their own music snippet. The user 12 may choose their song snippet, records their voice, chooses or records sounds and sends the result as a sound for the purposes of this invention.

This process may equally occur via a games console 14, via a game that is loaded on a mobile device 14, via a game that can be downloaded to a mobile device 14, or by a mobile or handheld games device 14 that has the capability to interface with other devices 14. The language that is created or attributed to the user 12 via, for example, project website 1, or the game, will be able to used as language for use on mobile phones and/or other equipment and/or devices 14.

Within language settings, a user 12 may be able to create their own song or song snippet by singing to backing music provided at project website 1. The user 12 may have the opportunity to select a band track based on their level of musical experience, and/or based on their taste. They may also have the opportunity to use songs, music or song snippets that reflect their mood, etc.

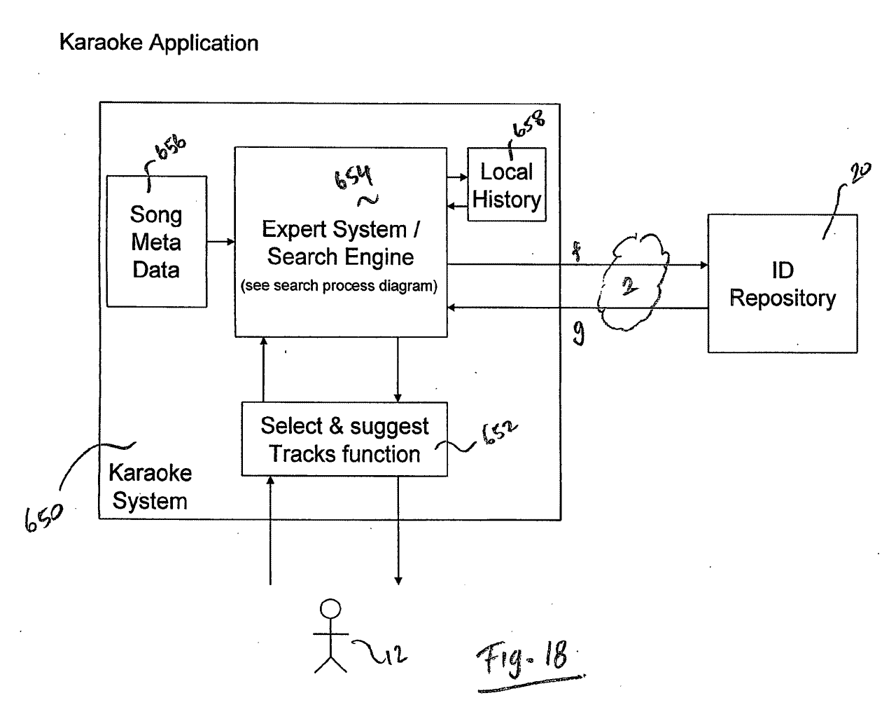

In FIG. 18 there is shown a block diagram which illustrates how a user's personal ID profile created in accordance with any one of the communication methods and/or systems of the present invention may be utilised with a karaoke system 650 in accordance with a preferred embodiment of the present invention.

In FIG. 18, it can be seen that in order to use karaoke system 650, a user 12 may be required to identify themselves to that system 650 via, for example, entering their identity information (identifier 40) in the form of a login id, or via entering their identifier 40 directly, or automatically, via some device that is attached to the karaoke system.

A module 652 of karaoke system 650 enables the selection and suggestion of tracks that the user 12 may wish to record or sing along with. This module 652 could be provided to user's 12 via a suitable user interface (not shown) integral with, or connected to, the karaoke system 650.

‘Select & Suggest’ module 652 communicates with a search mechanism 654 (which could be the same or a similar search mechanism to that described later with reference to Example 18), within karaoke system 650, in order to, for example, request recommended tracks for the specific user 12. The module 652 supplies parameters for the query, including the user identity (identifier 40) and any other constraints that the user 12 may have specified through the user interface (not shown) of karaoke system 650.

The search mechanism 654 issues a query via a (preferably secure) communications channel over a network 2 to the ID repository (database 20) of system 10, as indicated by arrow f. The query request provides the user identifier 40, and specific attributes that karaoke system 650 is interested in. The query sent to ID repository 20, results in the return of the attributes that are requested by karaoke system 650 to the search mechanism 654 thereof, as is indicated by arrow g. Access to the ID repository 20, and hence, the specific attributes requested, may be controlled via a policy that is implemented within ID repository 20. In this way, a user 12 may have has to previously provide permission to access ID repository 20, in order to allow the request sent from karaoke system 650. This could be via some other interface (not shown), or it could be achieved by way of a karaoke system 650 token (not shown) that is known only to the user 12 which provides for one-time access for the karaoke system 650 for that user 12.

The returned attributes are used as a basis object for issuing a query within the karaoke system 650, against the Song Metadata (see block 656) to locate songs which provide the best match for the user attributes (basis object). This may include note range, key, rhythm, and/or tempo of the music. A local history database 658 is retained within karaoke system 650 in order to allow previous recommendations and choices to be used to influence the search for the basis of future searches. For example, the user 12 may search for songs “like” a song previously selected. This search would use the previous song as a basis object as the subject of the search.

A candidate set of songs is then returned to the user 12 through the user interface (not shown) for action by the user 12, with any action being captured for later use as described above.

A preferred method of operation of a karaoke system 650 in accordance with the invention, may be summaries as follows: (i) user 12 makes a choice on whether they wish to use a music snippet, a track with someone else singing, or to sing themselves; (ii) if user 12 wishes to sing, user may be required to select their level of ability (beginner, medium, advanced); (iii) user 12 chooses a song (which may be categorized into levels of singing ability, etc) and chooses the length of snippet (which could be selected from a choice of say three different offerings depending on technical capabilities of the associated device 14), then records their own voice using a microphone (not shown) attached to their communications device 14; and, (iv) the song, or song snippets, are stored in the user's 12 language file (identifier 40) and may be uploaded to the user's 12 mobile phone 14, etc, if they wish to use those file in future.

The process of creating user generated music could also be the subject of a mobile or other game device 14.

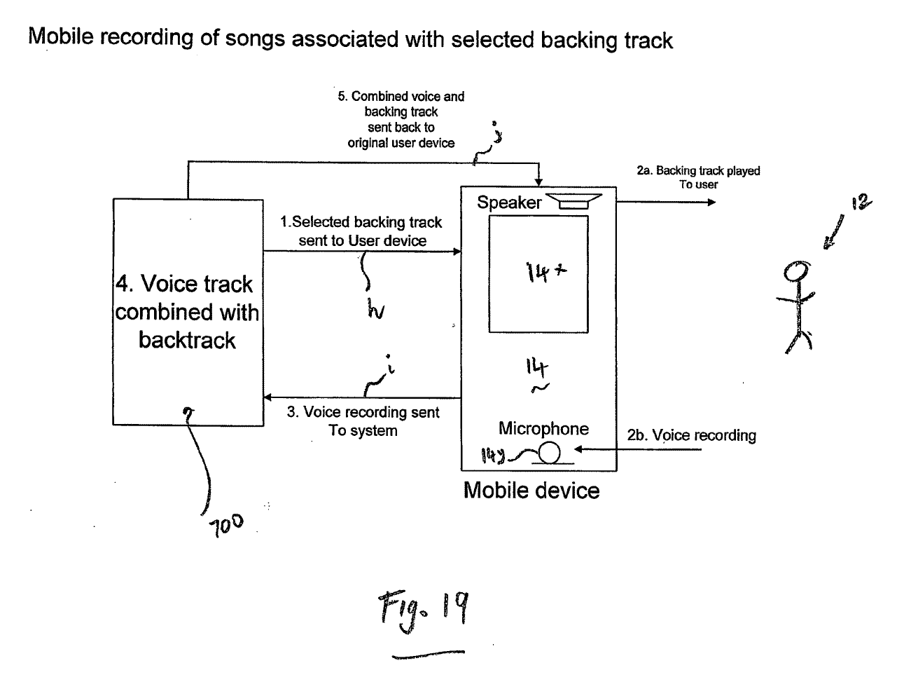

In FIG. 19 there is shown a block diagram which illustrates how a user's personal ID profile created in accordance with any one of the communication methods and/or systems of the present invention may be utilised with a music recording device 700 in accordance with a preferred embodiment of the present invention. The music recording device 700 being suitable for mobile recording of songs associated with selected backing tracks, etc.

In this figure it can be seen that a mobile user 12 may select a backing track using their mobile device application interface 14x, e.g. a screen or keypad, etc. The selected backing track is then downloaded to the mobile device 14 for immediate or later use, as is indicated by arrow h. The backing track may include a voice track to enable the user 12 to sing-along with the music if they do not know the words. This voice track could be removed when the recorded voice track is combined with the backing track.

User 12 may activate the “recording session” on their mobile device 14. An application on the device 14 may then simultaneously play the backtrack (see—2a) while it records the user voice track through a microphone 14y on the device 14. Music recording device 700 then either combines the voice with the backing track into a new music file on the device 12, or the user 12 can opt to have the voice recording sent to the service to effect the combination, as indicated by arrow i.

The music device 700 may then combine the voice track with the backing track using a variety of signal processing techniques to adjust the track for key, speed and to add additional effects to improve the quality of the voice track in relation to the backing track. The resultant combined voice and backing track file may then be sent to the user 12 via a mobile device delivery channel, such as MMS, etc, or to the original application (not shown), as indicated by arrow j. This file can then be used as a ring-tone, etc, on the phone 14, or in others ways as desired by the user 12.

### Example 14

In accordance with yet a further aspect, the communication method and/or system of the present invention may interrelate with other cross media programming of content, for example, as part of television, film, and/or other new media projects that will be associated with this invention. Language (including symbology, images, sounds, movements, and/or other sensory means of expression) could be used within the content of the programs and/or projects. Meanings of the language used will be defined within the context of the content of the specific programs, but the television and/or new media offerings will be interactive, and viewers could be invited to participate in the evolution of the language's meaning.

The symbols which will form part of the generic structure of the programming will be the start—viewers will be invited to be involved in providing feedback, voting, and suggestions for the program content via, for example: (i) an interactive website; (ii) mobile phones and/or similar devices 14; and/or, (iii) social network interactions. The cross media platforms will interrelate to provide a process of discovery for the viewer—i.e.: in addition to the entertainment values of the program, viewers will be encouraged to take an active approach and learn new things about themselves and take the first steps towards active self expression. The invention in this context is the development of an interactive, evolutionary method for creating language across various interrelated media platforms.

The invention focuses on a method whereby broadcast or digital media contributed by individuals or groups is assembled online, moderated, produced and distributed to a range of media capable devices.

It supersedes prior art in the area of digital media production to allow for a structured workflow from a range of source devices following one or both of the following models: (i) fitting a predefined production template; and/or, (ii) following comprehensive production directions.

Media elements may include any, or all, of: video; audio; computer graphics elements for subsequent rendering and production; images; text, avatar data; and/or, style guides—e.g. colours, fonts, and/or, smells/aromas.

Users 12 are able to via a central application see what type of elements are being sought, and through a guided workflow, contribute items either individually or collaboratively contribute towards the production of a final media product for limited or broad distribution.

Producers are able to establish a framework for a media product and seek input via an online application conforming to a production running list and/or a range of production directives.

As shown in FIG. 17, a suitable production system may include:

(a) a Programming Framework (item 1)—which may be a software application containing the following logical functions: a Workflow & Access Control module (item 2)—which could orchestrate key functions in the application in conjunction with conventional content ingestion and publication workflows in, for example, a Content Management System (item 13)—with the functions in (item 13) being exposed by standard programming API techniques (including exposure as web services) in order to enable content elements to be uploaded into a preproduction work area for further editing prior to submission for moderation and further production and publication—the function of (item 13) also controlling access of users 12 to elements contained in the production system—granting read and/or write permission on the basis of being an individual contributor or a member of a group of contributors (in the group case, contributors would be able to see, and depending on permission, edit contributions of other group members); a Production Directives module (item 3) —which could be a workspace where production directives from the shows producer are made visible to individuals and groups wishing to make contributions—including directives such as video formats, suggested locations, suggested styles, and could include a detailed running sheets for the final media product (e.g. scene orders/lengths, etc); a Programme Template (item 4)—which could be a media product template which could include drag and drop slots to insert different media elements into to lead to a final produced media product; a Private Workspace (item 5)—which could be an area visible to an individual user who is submitting contributions towards a media product—the user 12 having visibility of previously submitted items and their status in the overall workflow; a Group Workspace module (item 6)—which could be an area where groups can collaborate over submissions—media elements can be added, previously contributed elements can be incrementally added to, group members can exchange votes on changes contributed; a Public Workspace module (item 7)—which could be an area where all individuals with access to the application have visibility of “public” contributions prior to further production steps—access to the Workspaces (items 5 to 7) preferably being all read and/or write for authorised users (individuals, groups or all application users); a Media Quality Control module (item 8)—which may be a function that, in conjunction with the Content Management System (item 13) and Production Directives (item 3), may perform a quality check on the suitability of the media for further production steps—with the checks including: source format (e.g. to check for suitability for transcoding into other delivery formats); length (e.g. against production rules); source quality (e.g. the level of audio or video noise in the source media); and/or, source content (e.g. for inappropriate content—i.e. images, sounds, and/or words)—the Media Quality Control function (item 8) providing guidance through the User Interface (item 11) as to the suitability of contributed media and may result in the acceptance or rejection of the media, or the conditional acceptance whereby warnings are given as to potential downstream production issues resulting from issues with the source media; Media Elements (item 9)—which may be a library of media items provided by the producer for use by the contributors—industry standard techniques could preferably be utilised to manage digital rights and prevent unauthorised duplication around this material to prevent inappropriate use (the media items including: graphics, video intros and/or outros, music, sounds, images, and/or avatar information); a User Language module (item 10)—which could be a library of language elements (e.g. text, sounds, smells, colours, music, video elements, etc) that characterise the production and may include items based on individual contributions; and/or, a User Interface (item 11)—which could be a function to present the application to a range of possible devices and channels (e.g. items 16 to 21 in FIG. 17);

All data coming through the Programming Framework (item 1) may be tagged with metadata from contributing users 12, or the Production Function (item 12—see below), and may be stored along with the source media in the Content Management System (item 13);

(b) a Production Function (item 12)—which may be a fully or partially manual, or fully automated, function that runs the full workflow for the media product (including content moderation), and which may have interfaces to: Programming Framework (item 1)—to provide Production Directives (item 3), Media Elements (item 4) and to verify workflow; Content Management System (item 13—see below)—for the further production of the media product following the inbuilt workflow of the Content Management System (item 13)—moving items from pre production to a Content Delivery System (item 14—see below) for distribution;

(c) a Content Management System (or “CMS”) (item 13)—which could be a standard CMS utilised for the storage of user data in the private, group and public workspace constructs, through the management and production of web or broadcast media products—it may include the ability to transcode source media into a range of formats to suit the target channels and devices (e.g. Documentum); and,

(d) a Content Delivery System (item 14)—which may be a standard Content Delivery System utilised for the assembly and controlled distribution of media in formats suitable for the target device based on the Media Distribution (item 15) needs—media distribution can occur to: broadcast TV; cable TV; interactive TV; games consoles; on-line web services; mobile devices; and/or, mobile/portable gaming consoles, etc.

The Programming Framework (item 1) application may be accessed via a range of devices and methods via the User Interface (item 11) function. These devices and methods may include, but are not limited to: a browser or client running on Networked Portable Gaming Consoles (item 16)—as for example Sony PSP or Nintendo DS type devices; a browser or client running on a Mobile Device (item 17); a browser or client application running on a Computing Device (item 18); a browser or client application running on a Games Console (item 19) —as for example a Microsoft XBox, Sony PS3 or Nintendo Wii; a browser or client running via an Interactive TV system (item 20); and/or, a browser or client running via a Cable TV system (item 21)—e.g. a set top box, etc.

Communication between various devices, as indicated by arrows k, could be provided by any suitable means, but is preferably provided via industry standard IP technologies such as TCP/IP over a range of access networks (e.g. WLAN, DSL, Cable, Cellular, and/or, DVB back channel).

By way of an example, a User “Y” is a member of the Group Workspace (item 6) for Program X, and has been assigned Access Level 2 since he/she is a group moderator. User Y has a particular interest in music and enjoys contribution and is well aware of the Production Directives (item 3). User Y downloads a drum beat from the project website 1 (see FIGS. 1 & 2) to her mobile phone 14 (or item 17 in FIG. 17). He/she then utilises the drum beat track as a bed to add other musical sounds, and records bird sounds over the top of the drum beat. Once he/she has completed adding to the music file and thinks it is complete, they then uploads the completed file to the Workflow and Access Control area (item 2) for editing—and—then the file is submitted to the Group Workspace (item 6) for comment.

The group decides that the track is most suitable for Character Z in the Program X series. The file is checked for suitability via the media control function (item 8) in the Programming Framework (item 1), and the music file and Group Workspace's (item 6) comments are sent on to Production Function (item 12) for approval. For future reference, the music file and its component parts may be stored within User Language (filed under Program X with User Y identified as the file's author) in the Programming Framework (item 12).

In another example, User “L” is a member of the Group Workspace (item 6) for DIY programming. He/she has created the group with friends. He/she is assigned Access Level 1 since he/she is a group moderator and programming facilitator. User L checks the available Media Elements For Use in Contributions (item 9), checks the available Programme Templates (item 4), and posts his/her suggestions for a program to his/her group of friends in the Group Workspace (item 6). His/her friends draw on their stored elements of language in User Language (item 10) and post details in the Group Workspace (item 6). The friends check the files with the Production Directives (item 3), pass the files through Media Quality Control (item 8), and having confirmed the files are suitable, create and assign an identifying icon for the project and its files and post the language files in the icon (identifier) within the Workflow and Access Control area (item 2). Other friends may then follow a similar process as they build up the content required to make up the elements that fit within the template (item 4). Once completed, the Program is published.

### Example 15

A corporation may license the method and/or associated products provided by way of the present invention, in order to enable the effective indexing, filing and/or storage of information with the use of the project's multi-sensory identifiers 40-4c, created by the corporation, its staff, and with input from a project administrator. Such an indexing and filing system would operate in a non-linear way—i.e.: visually the library map acts to provide large branches of themed materials and links, etc. As a user 12 drills down, the information folds into the previous branch so a user is always aware of the overall picture or macro perspective when the user 12 is dealing with a micro issue.

This process enables users 12 to collate and index materials effectively with use of symbology and multi-sensory icons, etc, so that a user 12 always has multi-level reference points when searching for relevant information. The internal information network may be linked to the public external project website 1, and for continuity accord with the project's public offering of multi-faceted identified networks and communities (see, for example, FIGS. 12 to 15b).

### Example 16

A unique visual display allows staff members of a corporation or other users to easily target the access and posting of specific information while simultaneously having access and awareness of the big picture (see, for example, FIGS. 13a to 13c).

### Example 17

Incorporation of attribute identifiers (e.g. individual 40, group or corporation's ID's 40a, mood, or other attributes) into an organisation's existing means of profiling users 12 is possible in many instances, by way of example, via: membership clubs; frequent flyer clubs; and/or, medical iDs, etc. Currently, organisations such as the operators of airline frequent flyer programs profile their customers details within a customer card and associated database. Customer preferences such as diet, etc, are referred to and acted upon when a booking is made.

Using the project's attribute identifiers 40b, a corporation could provide members with much more targeted satisfaction based on the information embodied in their IDs. Their current mood, and/or a whole range of preferences, may be easily stored and accessed via a project website 1 (or licensee's website—not shown—etc).

It will be appreciated that this preferred embodiment could be incorporated into the exemplary corporation based operational structure shown in the GUI's 1x of FIGS. 13a to 13c.

### Example 18

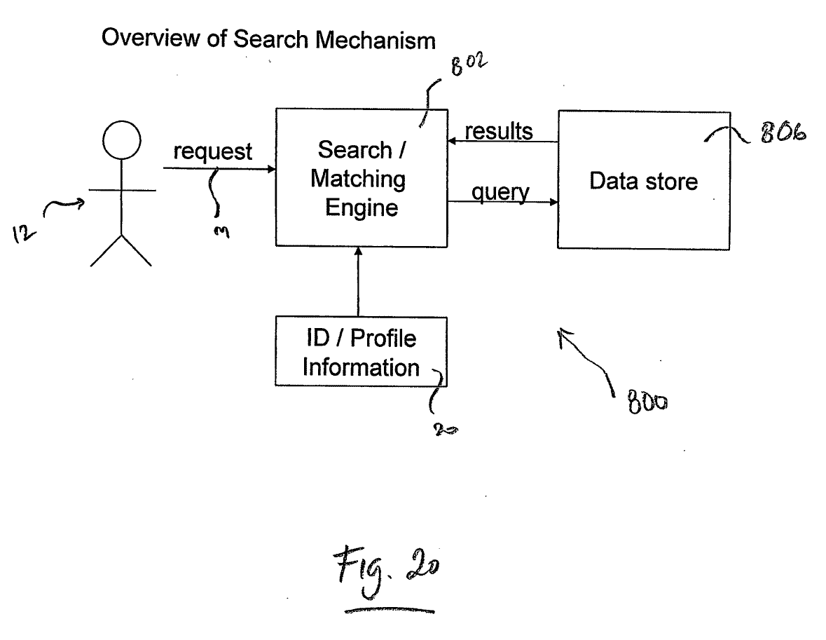

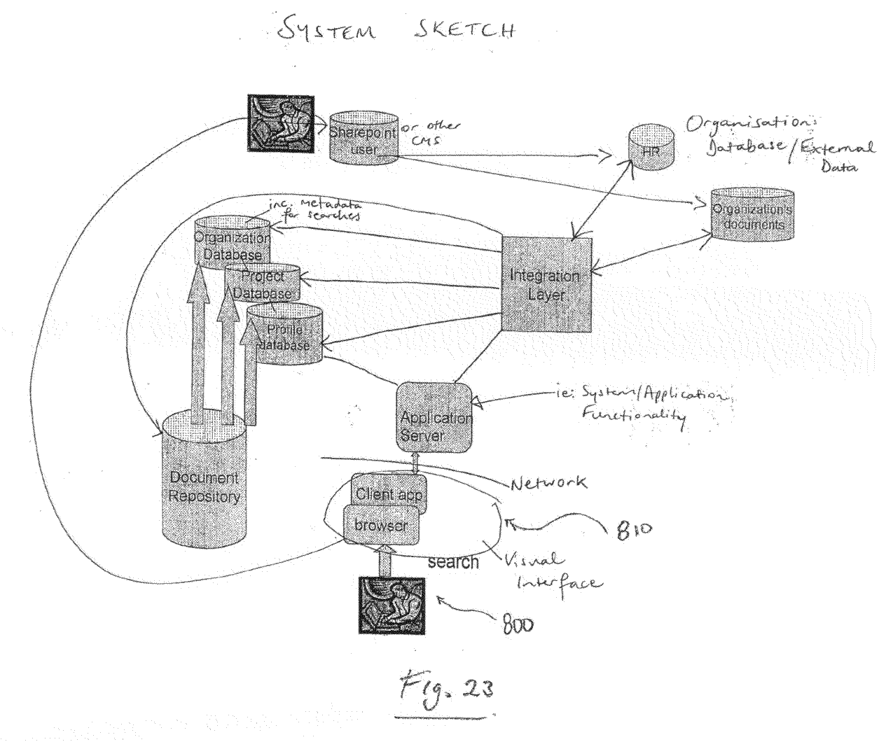

In accordance with yet a further aspect, the communication method and/or system of the present invention may provide a “Search Mechanism” 800 (see, for example FIG. 20 or 23), which may be a function used for categorised matching of user attributes, etc.

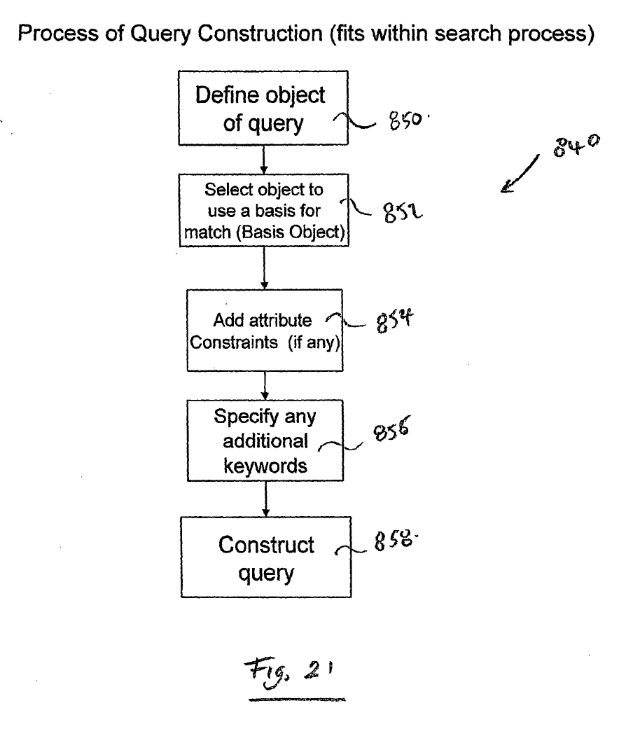

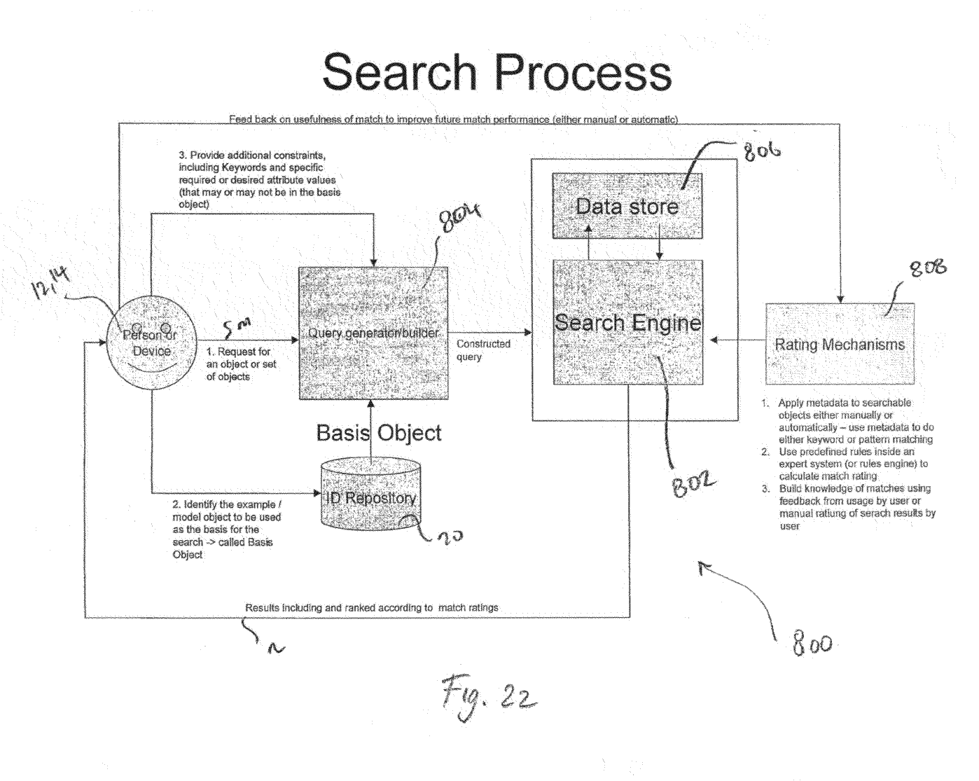

In FIG. 20, a simplifier block diagram illustrating an exemplary search mechanism 800 that can be used in accordance with the invention is shown. In FIG. 21, a flow diagram is provided in order to illustrate an exemplary process of query construction for use within the preferred search mechanism shown in FIG. 20. And finally, in FIG. 22, a more detailed block diagram of search mechanism 800 is provided for illustrative purposes.

Referring to FIGS. 20 to 22, it can be seen that a user 12 may define the object of a query (e.g.: they may be looking for: a person; document; group; project; organisation; TV show; video; picture; sound; and/or, any multimedia file, other attribute, file or entity), utilising search mechanism 800, and then match it with the ID of the same range of items.

In accordance with search mechanism 800, a search engine 802 is used to select aspects of the individual, group, project, or corporate ID, that are relevant for the requested search. The user 12 is then able to select from a defined list of specialisation attributes, etc, and then specify the result type requested (e.g.: the file type, etc). This process allows for an ongoing refined search which commences with a matching of attributes with a defined person, group, entity, document, or file, etc. By way of example, if a project manager wishes to organise a retreat for project participants, she may: (i) input the project ID (identifier 40b) which would have referenced within it all the individual IDs (identifiers 40), and the focus of the Project; (ii) make a selection of what she is looking for e.g.: “retreat”; and, (iii) add the specialisation attributes “destination” and “type of activity”, and/or add further arbitrary keywords, to further refine the search.

By way of another example, a user 12 may wish to search for an organisation to invest in that has a good sustainability track record. The user 12 could be familiar with the Project, and its accreditation process, whereby corporations are given accreditation and symbology applied to their IDs when they pass accreditation requirements. The user 12 inputs the Project's sustainability symbol into the search query field (as indicated by arrow m in FIG. 20—and—block 850 in the case of the preferred query construction process shown in FIG. 21), and may add: good match for “organisation”, the specialisation—locality “Australia”; and/or, other keywords as required. The result of this search would provide a list of corporations with sustainability accreditation. In addition to providing a ‘list’ of search results, search mechanism 800 may also provide a visual display from which would enable the user 12 to determine all of the corporations with such accreditation, and see at a glance the breakdown of the search according to the additional specialisation, and/or other keyword items.

Utilising the latter search option in case of search mechanism 800 being integrated into an existing organisational or corporate infrastructure (see FIG. 23—which shows a block diagram illustrating same), the multi-faceted graphical functions would enable more complete and precise comparison of organisations for a user's 12 reference. User 12 may also be able to drill down to further specifics on the organisation by pushing the “3D Enhanced View” button 566 (see FIG. 13c) which would provide much more detail on that corporation, and/or reference material that the user 12 may be interested in to be able to make an informed choice.

Referring back to FIG. 20, it can be seen that the triggering of a search is undertaken when a user 12 requests a search from an appropriate interface, as is indicated by arrow m. This may be via a generic search interface such as a web browser from or through an application specific search interface that is integrated into an application. The issuing of a search request to search mechanism 800 requires the user 12 to directly or indirectly specify a number of aspects of the query.

The various aspects of a query that may be specified to make use of the search mechanism 800, are depicted in the query construction flowchart 840 of FIG. 22, these being: (a) the object of the query (block 850)—this being the type of object, or types of objects, that a user 12 is searching for, such as, for example, the user 12 may be searching for other people, documents, multi-media objects, and/or, organizational units—the query construction interface 804 (see FIG. 22) of the search mechanism 800 being an interface that will allow these target objects to be identified; (b) the selection of a Basis Object (block 852)—the Basis Object being an object that will be used as the basis for the search, in other words, this is the object whose attributes will be used to match against the objects in the datastore 806, of search mechanism 800, to determine the relevant and/or related objects that comprise the search results; a rating algorithm (see item 808 in FIG. 22) may be used to determine how well each stored object matches the various attributes of the Basis Object, and to generate a rating which is used to determine whether the object is included in the search results, and/or the position (or rank) of the object within the search results; (c) constraints on the target object attributes may be optionally specified (block 854)—any specific constraints on the target objects may also be provided to enable the search engine 802 to locate the appropriate objects, such as, for example, if a persons object is specified as the target object, then an attribute of that persons object (for example, age) can be additionally constrained to a set of values (e.g. an age range from 30-40 years old)—these additional constraints could be applied using an AND or OR operation, and also using an ANY or ALL requirement for the constraints to enable the user 12 or system issuing the constraint to expand or restrict the scope of the search; and, (d) finally, any additional keywords that may be used within the search can be included in the generated query (block 856).

The constructed query (block 858) may then be submitted to the search engine 802, which executes the search, and displays the search results as indicated by arrow n in FIG. 22.

The results of the search are returned to the query initiator, or user, for display (here refer to items 12,14 of FIG. 22). The display mechanism may be independent of the search mechanism 800, and may be a text based listing, a set of objects in a machine readable format that may be operated by a system or a application specific data set that may be used by the visual search results display system as described below.

The integration with the visual search component may be via the submission of a query through data entered via the visual search interface directly, or via operations undertaken by the user 12 in the visual search interface, such as by clicking on a symbol to drill-down into that specific category. The results from the search mechanism 800 being provided to the visual search display mechanism 810 (FIG. 23) as a data set in a format appropriate for the mechanism to render the results for the user 12. This may require the visual display mechanism 810 to transform the provided results into a format that is more appropriate for the visual rendering of the results as has been described hereinabove with reference to other embodiments.

These examples therefore demonstrate that system 10 of the present invention provides users 12 with a novel and highly personalised means of communicating via the use of any suitable communications device, or application 14.

Although not discussed any of the specific Examples provided above, it will be appreciate that any one, or more, of the data constructs shown in FIG. 11 or 12, could be used for mood & ID profiles, or language creation, in accordance with the present invention. These additional data constructs including, but not limited to: texture; temperature; smell, and/or, movement. The only limitation to the use of such data constructs may be the capability of the specific communications devices 14 utilised by users 12 of system 10.

The aspect of the present invention revolves around a creation of a language for telephony or internet base interactions capturing a broad range of sensory expression. In addition to the creation and use of the language it introduces the ability to create and store data in a profile construct called the “Mood & ID Profiles and Language” in FIG. 11 (item 1). This includes elements that reflect and communicate an identity and/or mood of an individual 12, including, but not limited to, the elements of: Text (1a); Audio (comprised of Sound samples (2a) and Music (2b) sub elements); Design (comprised of an image (3a), Colour palette (3b) and fonts (3c)); Haptic elements (i.e. data to create tactile feedback through, for example, Texture (4a) and Temperature (4b)); Smell (5); and/or, Movement (6).

The Mood & ID Language can be predefined prior to use (by system 10), or could be constructed in realtime during interactions between users 12—with the ability to store chosen language elements in all cases.

Prior art attempts have been made in the area of rudimentary communication and presentation of user states through emoticon icons and basic text (e.g. Yahoo Instant Messaging, Skype, etc), on both web computing environments and mobile devices. In addition to this, there are also a range of communication media (e.g. MMS, e-mail, web based social networking services, etc) that allow for the transmission of a broad of range of media including sounds, text and images. However, these forms of prior art communication are essentially static and unstructured—and rely on items from different sources that are not easily exchanged or integrated—meaning no common language can be developed, i.e. all items remain fragmented.

This invention extends substantially the ability to effectively communicate a full range of expressions, emotions and status between individuals and/or groups. It allows for the full integration of language elements and allows for the creation of a structured reusable language between individuals or groups.

More specifically, in the case of system 10 of the present invention, text may be a string of characters reflecting the mood of an individual 12—entered by the individual via a user interface (either from project website 1, or a communications device (14)).

Sound (i.e. item 2a in FIG. 11) may a digitised sound grab of a specific standard length and coding scheme created or selected by the individual 12 for inclusion in the mood profile. Music (item 2b) elements may be digitised musical information of a defined length and coding scheme that can be played back at the time of browsing, for example, contacts information (page 46 in FIG. 4a) of identifiers 40, during the initiation of contact with an individual 12 (i.e. could be a ringtone, etc), during the communication, or at the closure of the communication with the individual 12. The Music (2b) element may be combined during playback with a Sound element (2a), etc.

Image elements (3a) may be digitalised graphical images created or selected by an individual 12—i.e. they could be, for example, photographs, videos, drawn images, or animations of a defined size and colour depth for inclusion in the mood profile, etc. Similarly, Colour Palette elements (3b) may be selected by an individual 12 for inclusion in their mood profile, etc. Likewise, Font elements (3c) may be used to represent a group of fonts used during the presentation of the Mood & ID Profiles, etc.

Texture (4a) and Temperature (4b) elements (or data) may be stored in a profile and applied in the cases where the communications device 14 involved has the ability to provide haptic feedback based on this data. The texture and temperature data ranges and types would be standardised to enable a finite variety of selections to choose from. Such items could be derived from images (3a), music (2b), or sounds (2a) created or selected by a user 12—for example a shape drawn by the user 12 could be converted to haptic data to be felt through a touch surface, feedback glove, or similar device.

Smell (5) elements could represent data be used by a device 14 that is able to translate selection data to a specific release of an odour. The selections may be standardised to a finite variety of selections—e.g. “Sweet”, “Citrus”, and/or “Smokey”, etc.

Finally, Movement (6) information could be used as a record of dynamic information relating to the movement of a device 14 in space, and the dynamic animation or orchestration of other Mood & ID elements. An example of Movement being recorded is the capturing of the action of a user 12 shaking their phone 14 out of frustration.

An example of the use of the various data constructs or elements shown in FIG. 11, could be as follows: “Susan” has a profile with: Text=“Having a great day today”; Audio: Sound being birds chirping; Audio: Music being a section from Vivaldi's “Spring” from Four Seasons; Design: Image being a picture of Sue in the sunshine smiling; Colour Palette: A collection of greens and yellows for use in background graphics and text colours; Haptic: Texture being “smooth”; Haptic: Temperature being “warm”; Smell=Honeysuckle; Movement=make a movement transducer sway slowly 3 cm left and right repeatedly and scroll the Text “Have a great day today” right to left in green over a wavy yellow background.

An individual 12 will have at least 1 Mood & ID Language profile—the Individual Mood & ID (item 8 in FIG. 11) comprised of specific selections of the profile elements (1). The individual may over time build up a library of profiles which may be chosen through a short hand code—i.e. p1 is profile 1—“happy” or p2 is profile 2—“nervous”, etc.

The individual 12 may be associated with one or more groups. Each group will have a predefined profile available—the Group Mood & ID (item 7 in FIG. 11). The individual 12 may transfer (as indicated by arrows a in FIG. 11) any or all of the data elements from the group (7) to their individual profile (8) via a project website 1 (i.e. hosted by network server 16) or a communications device 14.

As already described, in the case of home or building automation, the Mood & ID Language data can be used to control environmental factors in the home or building including lighting, temperature, smell, music and images.

All data elements of a given type are interchangeable between all specific Mood & ID Profiles—i.e. the Texture data (4a) from profile “x” for individual “x” can be copied into a central library for reuse by other individuals or groups, or could be transferred to profile “y” for individual “y”.

All data is stored in a repository (database 20, etc) which may be a centralised or distributed database containing Mood & ID Profiles and data elements.

As is illustrated in FIG. 12, data elements may be populated in a profile (8a) on a communications device 14 by an individual 12, by, for example, dragging and dropping (as indicated by arrows b) elements into the profile, with visual feedback on which elements are populated and which are not (via a list, grid or circular layout). As dragging and dropping occurs, a compatibility check is made to ensure, for example, “image” data goes into the “image” slot (3a), etc. This may be achieved using standard techniques such as tracking MIME types or file header or extension types.

In the background, file conversion would take place where relevant (for example, of an image to the correct resolution, colour depth and or file format). The individual 12 may then name and save the completed profile—which could be stored centrally in the Mood & ID profile repository (8).

The same or a similar process could obviously be used to populate group ID information, etc.

As already discussed, an individual's Mood & ID Profile (8) is stored in a repository (i.e. database 20) in accordance with system 10. As Person A′s mood changes—the items within their Profile (8) are changed—by Person A, via interaction between project website 1 and communications devices 14. These interactions may be via IETF standardised web or IP based communications techniques.

Network server 16, of system 10, coordinates interaction between devices 14 for communication or transfer of Mood & ID Language data. Such may include a new networking service or a modified version of any typical web social network service, or network gaming service (e.g. Gamespy) supporting PCs, Mobiles, handheld gaming devices or consoles, altered to include the ability to handle any or all elements of Mood & ID Language data during transactions between users 12.

Person B interacting with Person A via another communications device 16, etc, will see the results of Person A′s profile (8) on their device 14—(based on device support, via any or all of the following): Person B may see the Text, Image (3a) themed using the colours of the Colour palette (3b); Person B may hear the Sound (2a) and Music (2b) as they scroll the cursor through the list; Person B may experience haptic feedback based on the Texture (4a) and Temperature (4b) data in the profile.

Activities Person B may be undertaking include, but are not limited to: browsing their favourite contacts list on their device 14; initiating communication with Person A, via, for example, voice call, video call, text message, email, chat, etc; receiving communication from Person A (voice call, video call, text message, email, chat); Person A and B will continue to experience Mood & ID profile changes during a communications interaction facilitated by the ongoing simultaneous session between their communications device 16 and/or project website 1, etc, provided by system 10; and/or, language elements may be altered/added to during an interaction—for example additional sounds added to a sound or music element.

Person A or B may be individuals 12 that may be representing an organisation or media/production network, and the interaction may be stored or used in realtime or on demand broadcast basis, etc.

Network 2 may contain an enhanced version of a presence server (18a in FIG. 2) which has been adapted to accept presence profile data elements in line with the Mood & ID Profile data constructs (1—of FIG. 11) using web or IP techniques, as shown.

Industry standard methods could be used between the enhanced presence server (18a) and mobile communications devices (14), and/or network server (16), to communicate presence status updates. Interfaces therebetween would be based on standard presence communications approaches—e.g. 3GPP TS 23.141 (Technical Specification) Presence service; Architecture and functional description; Stage 2; or, 3GPP TS 24.141 (Technical Specification) Presence service using the IP Multimedia (IM) Core Network (CN) subsystem; Stage 3.

On a mobile communications device 14—Mood & ID Profiles may be updated either directly from the enhanced presence server (18a)—for example, directly into an updated contact list view on the device 14, or via network server 16—for example, a client or browser based communications interaction.

Standard mobile communications devices, and networked computers, are now able to maintain parallel interactions (i.e. a data session and a voice call) via a range of standard technologies such as 3GPP Dual Transfer Mode, Simultaneous PDP contexts or SIP (Session Initiation Protocol) sessions. Hence, both forms of devices are now also able to support simultaneous applications (for example, as defined in the MIDP 3.0 standard for Mobile Devices). Both capabilities would therefore support the appropriate transport of Mood ID information before, during or after a communications interaction.

Group Mood & ID Profile Data (item 7—in FIG. 11) is a composite library of members Mood & ID Data conforming to the Mood & ID data constructs shown in item (1). As already discussed, groups each have a Facilitator with rights to add, delete and edit Group Mood & ID Profile Data (7). Individuals 12 can contribute new Mood & ID Language elements in the Group Mood & ID Profile (in the same way as the individual case), with the additional capability of the elements being visible to the group to select from during their interactions thereby building up a group language. When a group member wishes to change a data element, they may be presented on their communications device 12, etc, for example, with a list of existing language elements. The group member may also search or sort based on metadata associated with each data element including the data element name, value, individual (12) who created the element, the date it was created, or the number of times it has been utilised, etc.

Changes to language elements may be voted upon by group members the results of would could be stored along with language elements in network server 16 repository (database 20).

Group Mood & ID Profile Data (7) may also include a representation of the Group's “average” mood using the average values of all individual profiles making up that group. The rules to derive the average may be selected by the Facilitator for the group and could include (but are not limited to): the instant mood—i.e. the average snapshot of all moods at a given moment in time; the average mood—i.e. the average based on the utilization of language data elements amongst the group over a given time interval (e.g. day, month, week or year); or, either the average or instant moods for a subgroup of the group.

Group data would obviously be protected by standard security methods to prevent unauthorised access or editing of that data. Similarly, group data could be exposed by secure, standard API practices to allow for the authorised accessing of the data via 3^{rd} party applications for consumer or business work team use.

Group and individual data are not mutually exclusive—i.e. individual interactions between group members will also allow the use of a complete range of Mood & ID data pertaining to both their individual and group membership.

In the context of the various visual search and information visualisation (i.e. organization/network mapping, information, and/or ID displays) aspects of the present invention, scalability is enabled through the ability of a user 12 to categorize information or IDs further, as needed, so that the display is visually manageable and user friendly. This is clearly demonstrated with reference to the break-away, or transition functions of the corporation-based organisational visual displays shown in FIGS. 13a to 15b.

Other sensory language may be used in addition to the visual attributes, wherein the addition and choice of other sensory language will be based on content function and determined by the capability of the device 14 providing the display.

In accordance with the invention, information displays may be used for: (i) organizational planning; (ii) as a comparative tool to enable specific choices or choice of pathway to explore further; (iii) visualisation of statistics—i.e. they may allow for multi-faceted views so that various aspects, relevance and overlaps are clear; and/or, (iv) since all information and IDs will have identifying language, identification of the source or home of the item (person, group, document, etc) within the organization or network is clear at a glance. Given the unique 3-tier visual tool (“Tree View”, “Search View”, and “3D Enhanced View” shown in FIGS. 13a to 13c), a user can at the touch of the button go to where, for example, a person or document sits/resides within the network or organization in order to see further context related thereto.

User's 12 are able to scale organisational or network growth with the use of macro/micro functionality embodied by this invention. As the organisation or network grows further levels of categorisation and matrices are added by the user 12, as required, so the visual display (see, for example FIGS. 13a to 13c) remains visually manageable for the user 12.

A user 12 has a multi functionary experience using the visual search and 2D and 3D integrated viewing mechanisms provided within, for example, GUIs 1x of FIGS. 13a to 13c. All information and IDs may be referenced “in the field” so there is no separation. In this way, a user 12 has a multi functionary experience and has within their awareness the whole picture at all times.

User's 12 may have access to a unique display of statistical information utilising the “Tree View” 550 (2D or 3D), iconography displayed on the tree that references the main categorisations within the statistics. User 12 may also have the ability to touch the “3D Enhanced View” button 566, on the visual display and then drill down to further particulars in a 3D environment—if they require further detail or postings associated with the statistics initially provided.

In the context of television or similar programming interfaces used in accordance with the invention (see, for example FIG. 17), within such a TV or other programming environment, viewers or users 12 may be able to vote on satisfaction, performances, and/or other subject matter utilising a multi functionary voting system that gives value to multi-faceted attributes. For example, in the case of voting on performers' performances, instead of receiving a vote from 1 to 10, viewers or participants could rate the performance in various ways—e.g. in terms of: musicianship, creativity, individuality, freshness, stylisation, etc. These various attributes could be collated and used as a visual display in accordance with the unique visual display system embodied in this invention based on the viewers inputs, etc. By way of example, the glow function could be utilised so viewers could see the strength of votes, but viewers would also be able to see visually other aspects that viewers have appreciated about a performance utilising the various other elements (e.g.: colour, tilt, rotate, extrude, etc—as were described with reference to FIGS. 14a to 14e).

Within an organisational structure, organisations may be able to use the “extrude” graphic function to display the members of an organisation who are central to the running of the organisation—so if they are extruded from below the main drivers of each department, they may sit underneath their departments to visualize the fact that they are the drivers of the organisation. An organisation could tailor this function in multiple levels if they wish to visualise the hierarchy. The organisational mapping options are endless with the user able to set any of the graphic functions for specific uses and make different combinations of such functions to compound the visual effect as required to differentiate further categories. The extent of such possibilities will depend on the visualisation technology employed—for example, 3D animated software will provide many more options in terms of differentiation, whereas the more widely used Flash will provide allow for such differentiation but to a more limited extent with less tailoring options.

The present invention may therefore also allow a user 12 to create a 3D identifier that could represent a “box man” as a tool for expression and as a storage device for information (see, for example, FIG. 10a). The minimal expression of a user's 12 ID (identifier 40) being a (2D) square box. Through the various phases of transition, the square box can become a 3D animated cube which could then fold out to resemble a “box man”. Each facet of the “box man” could have various doors where particular information and other files are identified and stored. A user 12 may take the “box man” with him/her: (I) within the same platform for use as a navigationary tool and personal reference (including for use with interactions) within the site; and, (ii) for use on other platforms so all the user's 12 personal information are stored within the 2D or 3D “box man”, and available for use and reference. In the latter case, the method of employing or allowing this transportable functionality is analogous to transporting language created at the main site (project website 1) over to mobile and/or other platforms as hereinbefore described.

Once again, although not shown in the drawings, other applications suitable for use with IDs, and/or language, created in accordance with the present invention may include: hotels—which could provide guests with a physical ID product that could personalize settings within a room, or within other areas of a hotel, taking into consideration the attributes of users; logistics/transport industries—which could utilise ID's for ordering and/or delivery purposes—or in the case of public transport systems, could utilise physical sensors to read the number of people entering a tram/train, to make that information available as a visual display at all public transport facilities so users could see the best route for that day; banking and/or other financial institutions—which could utilising electronic and/or physical ID products to enable users to login and/or customize, for example, their on-line banking webpages, etc; voting systems—which could utilise user IDs to create statistical displays of voting information, etc; and/or, mail delivery systems—which could utilising the various aspects of the present invention for mail quantity and/or tracking purposes, wherein a output visual display could be produced for individuals or corporations to view in order to see where their consignment is at, etc.

The present invention therefore provides a system 10 and/or method 100,200,300,400 which enables personalised communication between various devices and/or applications 14 to be performed over a network 2, preferably the Internet or a suitable telecommunications network. In accordance with a preferred aspect, the present invention may also provide suitable products for use with the system and/or method of the invention, these products enabling personalisation of many other forms of communication devices which a user may come into contact with on a day to day basis.

While this invention has been described in connection with specific embodiments thereof, it will be understood that it is capable of further modification(s). The present invention is intended to cover any variations, uses or adaptations of the invention following in general, the principles of the invention and including such departures from the present disclosure as come within known or customary practice within the art to which the invention pertains and as may be applied to the essential features hereinbefore set forth.

Finally, as the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and the appended claims. Therefore, the specific embodiments are to be understood to be illustrative of the many ways in which the principles of the present invention may be practiced.

1. A method of communication, said method including the steps of: providing a repository for storing and/or sharing identifiers and/or language, wherein said identifiers establish the identity and/or other attributes of users, groups of users, entities, and/or items; providing at least one user operable terminal with controlled access to said repository and said identifiers and/or language stored therein; wherein said identifiers and/or language are used to convey information, messages, instructions, attributes, and/or expression for the purpose of enhancing and/or integrating communications.

2. The method of communication according to claim 1, wherein said identifiers and/or language are created or chosen by said users, groups of users, and/or entities.

3. The method of communication according to claim 2, wherein a first user, group of users, and/or entity, may create said identifiers and/or language, and further users, groups of users, and/or entities may refine, amend, update, improve and/or evolve said identifiers and/or language, or elements thereof.

4. The method of communication according to claim 3, wherein said identifiers and/or language are used as a means of expression that is driven by said users, groups of users, and/or entities, in order to convey personal attributes or identity thereof.

5. The method of communication according to any one of the preceding claims, wherein the communication is provided via a communications network, and is performed utilising any suitable communications protocol.

6. The method of communication according to claim 5, wherein the communications protocol is selected from the group consisting of: SMS; MMS; e-mail; Skype; VoIP; instant messaging; social networking platforms; HTTP; FTP; TCPIP; and/or any other suitable network based communications protocol, and/or any combination of the preceding protocols.

7. The method of communication according to claim 3, wherein said elements of said identifiers and/or language are selected from the group consisting of: still or moving images; sounds; smells; textures; temperature; movement; appearances; and/or any other suitable elements, and/or any suitable combination thereof.

8. The method of communication according to claim 7, wherein said at least one user operable terminal is selected from the group consisting of: communications and/or computing device; mobile terminal; mobile or cell phone; PDA or Palm Pilot; television including internet, broadband, free to air, and/or mobile televisions; a server; rights expression voucher; games console; Flash Player; two way pager; pocket or tablet PC; auto PC; an appliance; and/or any other suitable device that may communicate via any suitable communications protocol.

9. The method of communication according to any one of the preceding claims, wherein said identifiers and/or language, or elements thereof, are used as various outputs for: interactions within social networks; television, gaming, or other programming applications; APIs; enhanced searches; home and/or building automation systems; bio-feedback or proximity devices; karaoke device; music devices; organizational mapping and/or planning tools; and/or any other suitable device, system and/or application therefor.

10. The method of communication according to claim 9, wherein when said outputs are used with said television, gaming, or other programming applications, said identifiers and/or language is/are amalgamated with tailored production directives to create new television, or other means of publishing content for output across various devices and/or platforms.

11. The method of communication according to any one of the preceding claims, wherein said identifiers and/or language are used as a visual representations of identity in order to facilitate organisational or network mapping, project management, indexing of files, and/or a multi-faceted integrated display utilising graphical functions.

12. A user operable terminal, suitable for use in accordance with the method according to any one of claims 1 to 11.

13. A communications apparatus, suitable for use in accordance with the method according to any one of claims 1 to 11.

14. A method of communication between a sender of an electronic communication and at least one recipient of that communication, wherein communication language is created by a first user and that language is utilised and further users are invited to further personalise that language, the method including the steps of: assigning to at least one element of language, any one or more of: an image; a sound; a smell; a texture; a temperature; a movement; an appearance; that is capable of being expressed on or from at least one electronic communications device that said recipient has access to; said sender inputting a message into a sender's electronic communications device, wherein said message contains said at least one element of language; said sender sending said message to said recipient's said communications device; so that, when said recipient receives or opens said message on said recipient's communications device of choice: in the case of a said image, it displays said image; in the case of a said sound, it plays said sound; in the case of a said smell, it emits said smell; in the case of a said texture, it adopts said texture; in the case of a said temperature, it becomes said temperature; in the case of a said movement, it makes said movement; in the case of a said appearance, it adopts said appearance.

15. A method of communication wherein communication language is created or utilised by a first user and that language is utilised, and further users and invited to further personalise that language.

16. A communication system, said system being operable over a communications network, said system including: at least one memory or storage unit operable to store and/or maintain identifiers and/or language, wherein said identifiers establish the identity and/or other attributes of users, groups of users, entities, and/or items; at least one processor operable to execute software that maintains and controls access to said identifiers and/or language for a plurality of users; and, at least one input/output device operable to provide an interface for said plurality of users to operate said software in order to retrieve and/or update said identifiers and/or language, and/or elements thereof; wherein said identifiers and/or language, and/or elements thereof, are used to convey information, messages, instructions, attributes, and/or expression for the purpose of enhancing and/or integrating communications.

17. A product or device, suitable for use with the system according to claim 16.

18. The method of communication according to claim 1, wherein said identifiers and/or language are incorporated into an operating system or other software application in order to simplify and/or personalise the navigation and/or other aspects of said operating system or other software application.

19. The method of communication according to claim 18, wherein said operating system or other software application is a digital or IPTV network, or a graphical user interface for same.

20. The method of communication according to claim 18, wherein said software application is a game.

21. The method of communication according to claim 1, wherein said identifiers are used within a graphical user interface in order to display different views and a link to different functions where relevant information is displayed according to a specific identifier that is chosen by a user.

22. The method of communication according to claim 1, used to convey mood, circumstances and related outputs.

23. A method of searching network content, utilising the identifiers and/or language provided and/or created in accordance with the method of communication according to any one of claims 1 to 11.

24. The method of searching according to claim 21, wherein search results are provided as a visual display, and further searching can be performed by way of breaking outputs or knowledge down utilising said visual display provided.

25. A method of researching users, groups of users, and/or entities, utilising the identifiers that are visually displayed in accordance with the method of communication defined in claim 21.

26. The method of communication according to claim 1, wherein said identifiers are used to produce visual maps of organisations, networks and/or knowledge based information.

27. The method of communication according to claim 26, wherein said visual maps can be broken and/or drilled down into layers or components as required.

28. A method of indexing, storing or integrating information, utilising the identifiers and/or language provided and/or created in accordance with the method of communication according to any one of claims 1 to 11.

29. A logistics system utilising the identifiers and/or language provided and/or created in accordance with the method of communication according to any one of claims 1 to 11.

30. A method of publishing, utilising the identifiers and/or language provided and/or created in accordance with the method of communication according to any one of claims 1 to 11.

31. A method or system of branding, utilising the identifiers and/or language provided and/or created in accordance with the method of communication according to any one of claims 1 to 11.

32. A method of voting or visually displaying information in a multi-faceted way, utilising the identifiers and/or language provided and/or created in accordance with the method of communication according to any one of claims 1 to 11.

33. A home, corporate, event or other physical or spatial automation system whereby the identifiers provided and/or created in accordance with the method of communication according to any one of claims 1 to 11 are worn, or set off by a sensor or other locating device, or set at a website, so chosen environments are set by a user or group of users to change or amend the environment according to identity, brand or mood attributes set within a users, group of users, or entities identifiers.

34. A system of accreditation whereby the identifiers provided and/or created in accordance with the method of communication according to any one of claims 1 to 11 are used to facilitate search or storing of information.

35. A karaoke or music system, or karaoke or music search system, utilising the identifiers provided and/or created in accordance with the method of communication according to any one of claims 1 to 11.

36. The karaoke or music system, or karaoke or music search system according to claim 35, wherein music outputs produce language elements for use with other aspects of said method of communication.

37. A knowledge management system, utilising the identifiers and/or language provided and/or created in accordance with the method of communication according to any one of claims 1 to 11.
